(19) United States
(12) Patent Application Publication
(10) Pub. No.: US 2006/0284140 A1
(43) Pub. Date: Dec. 21, 2006

(54) Novel materials for electroluminescence

(76) Inventors: Esther Breuning, Niedernhausen (DE); Aurelie Falcou, Frankfurt (DE); Susanne Heun, Bad Soden (DE); Amir Parham, Frankfurt (DE)

Correspondence Address: CONNOLLY BOVE LODGE & HUTZ, LLP, P O BOX 2207, WILMINGTON, DE, 19899, US

(21) Appl. No.: 10/561,739

(22) PCT Filed: Jun. 24, 2004
(86) PCT No.: PCT/EP04/06832

§ 371 Date: Feb. 7, 2006

(30) Foreign Application Priority Data
Jun. 26, 2003 (DE) 103 28 627.6

(51) Int. Cl. C09K 11/02; C09K 11/06

(52) U.S. Cl. 252/301.35

(57) ABSTRACT

The present invention relates to mixtures and to conjugated polymers which contain bridged carbazole structural units and structural units which emit light from the triplet state. The inventive mixtures exhibit improved efficiencies and reduced operating voltages and are therefore better suited to use in organic light-emitting diodes than comparative materials which do not comprise these units.

For about the last 12 years, broadly based research has proceeded into the commercialization of display and illumination elements based on polymeric (organic) light-emitting diodes (PLEDs). This development was triggered by the fundamental developments which are disclosed in EP 423 283. Recently, a first product in the form of a relatively small display (in a shaver from PHILIPS N.V.) has become available on the market. However, distinct improvements are still necessary for these displays to provide real competition to the currently market-leading liquid crystal displays (LCDs). In particular, it is necessary in this context to provide polymers for all emission colors (red, green, blue) which satisfy the demands of the market (efficiency, operative lifetime, operating voltage, to name the most important).

Various material classes have been proposed or developed as polymers for full-color display elements. One such material class is that of polyfluorene derivatives, as disclosed, for example, in EP 0842208, WO 99/54385, WO 00/22027, WO 00/22026 and WO 00/46321. In addition, poly-spiro-bifluorene derivatives, as disclosed in EP 0707020, EP 0894107 and WO 03/0207901, are also a possibility. Polymers which contain a combination of the first two structural elements mentioned, as disclosed in WO 02/077060, have also already, been proposed. In general, polymers which contain poly-para-phenylene (PPP) as a structural-element are possible for such a use. In addition to the classes already mentioned above, examples of other classes which are also useful here are what are known as the ladder PPPs (LPPPs, for example according to WO 92/18552), the polytetrahydropyrenes (for example according to EP 699699), but also PPPs containing ansa structures (for example according to EP 690086).

Furthermore, it has been reported that the introduction of certain arylamino moieties gives rise to an improvement in the properties: WO 99/54385 and DE 19846767 describe polyfluorenes whose efficiency and use voltage can be improved by copolymerizing derivatives of triphenylamine, tetraphenyl-p-diaminobenzene, tetraphenyl-4,4′-diaminobiphenyl or substituted diarylamino units into the main chain of the corresponding polymers. WO 01/66618 describes copolymers which, in addition to aryl units, also contain specific triarylamino- or tetraaryl-p-diaminoarylene units in the main chain.

A development which has become apparent in the last few years, in particular in the field of “small molecule” displays, is the use of materials which can emit light from the triplet state and thus exhibit phosphorescence instead of fluorescence (M. A. Baldo et al., Appl. Phys. Lett. 1999, 75, 4-6). These compounds are referred to below as “triplet emitters”. For theoretical reasons relating to spin probability, up to four times the energy efficiency and power efficiency are possible using such triplet emitters.

Whether this new development will establish itself depends strongly upon whether corresponding device compositions can be found which can also utilize these advantages (triplet emission=phosphorescence compared to single emission=fluorescence) in OLEDs. The essential conditions for practical use here are in particular efficient energy transfer to the triplet emitter (and efficient light emission associated therewith), a long operative lifetime and a low use and operating voltage, in order to enable mobile applications.

In recent times, there have been increasing efforts to utilize the advantages of triplet emitters which can be applied by vapor deposition for polymer applications too. For instance, hybrid device structures are being considered, which combine the advantages of the “small molecule” OLEDs with those of the polymer OLEDs (=PLEDs) and are formed by mixing the triplet emitter into the polymer. On the other hand, the triplet emitter can also be covalently bonded to the polymer. Both methods have the advantage that the compounds can be processed from solution and that no expensive and complicated vapor deposition process, such as that for devices based on low molecular weight compounds, is required. Application from solution (for example by high-resolution printing processes) will in the long term have distinct advantages over the currently customary vacuum evaporation process, in particular with regard to scalability, structurability, coating efficiency and economics. Soluble triplet emitters are disclosed, for example, in WO 04/026886. However, for these too, a suitable matrix material which enables efficient energy transfer to the triplet emitter is needed.

It is also known that blends (mixtures) of nonconjugated polymers, for example PVK (polyvinylcarbazole), with organometallic triplet emitters result in efficient electroluminescence of the metal complex (for example Chen et al., Appl. Phys. Lett. 2002, 80, 2308). However, the operating voltages for these systems are very high, which results in a very low power efficiency and thus does not enable any commercial application of these systems.

Blends of such metal complexes with conjugated polymers have likewise been described in the literature. Guo et al., (Organic Electronics 2000, 1, 15) and O'Brien et al. (Synth. Met. 2001, 116, 379) describe good quantum efficiencies with blends of a platinum-porphyrin complex with polyfluorenes, but the efficiencies in both cases are distinctly lower than in comparable devices constructed from low molecular weight compounds applied by vapor deposition. Zhu et al. (Appl. Phys. Lett. 2002, 80, 2045) describe a blend of a soluble iridium-phenylpyridine complex with a poly-para-phenylene. Here, better but still relatively low quantum efficiencies were measured. In particular, very high voltages were required here, which are an obstacle to industrial use.

In spite of the advances cited in the abovementioned publications and application documents, there is still a considerable need for improvement of such materials, in the following fields among others:
(1) The efficiency of light emission has to be increased still further. For this purpose, more efficient energy transfer to the triplet emitter and thus a more suitable matrix material is necessary. The fact that higher efficiencies are possible in principle is shown by the results with low molecular weight triplet emitters applied by vapor deposition.
(2) The current-voltage characteristic lines have to become even steeper so that high brightness is achieved at low voltages and the power efficiency is thus increased. This is of huge significance since equal brightness can firstly be achieved at lower energy consumption, which is very important in mobile applications in particular (displays for mobile telephones, pagers, PDAs, etc). Secondly, higher brightnesses are obtained for the same energy consumption, which can be of interest, for example, for illumination applications. In compounds which correspond to the prior art, the operating voltages are still significantly too high, which results in a relatively low power efficiency.

We have now found that, surprisingly, hitherto unknown conjugated polymers and mixtures which contain certain bridged carbazole units give rise to distinct improvements, specifically in the two abovementioned fields, i.e. the efficiency of light emission and the operating voltage, in comparison to blends or polymers according to the prior art. These materials are therefore provided by the present application.

The invention provides mixtures comprising
(A) at least one conjugated polymer,
(B) at least one bridged carbazole unit and
(C) at least one triplet emitter.

In the context of the invention, triplet emitters are understood to mean compounds which emit light from the triplet state, i.e. exhibit, phosphorescence instead of fluorescence in electroluminescence, preferably organic or organometallic triplet emitters which may be low molecular weight, oligomeric, dendritic or polymeric. Without wishing to be bound to a particular theory, all emitting metal complexes containing transition metals or lanthanoids are referred to as triplet emitters in the context of this invention.

The inventive mixture preferably contains at least 0.5% by weight of at least one conjugated polymer, at least 1% by weight of at least one bridged carbazole unit and at least 0.5% by weight of at least one triplet emitter.

A preferred embodiment of the mixture according to the invention comprises, as a bridged carbazole unit, at least one compound of the formula (I) 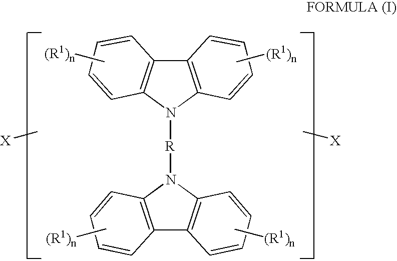
where the symbols and indices are defined as follows:
R is the same or different at each instance and is a straight-chain, branched or cyclic alkylene chain which has from 1 to 40 carbon atoms and may be R¹-substituted or unsubstituted, in which one or more nonadjacent carbon atoms may also be replaced by —NR²—, —O—, —S—, —CO—, —CO—O—, —CO—NR²—, —O—CO—O—, or is a bivalent, aromatic or heteroaromatic ring system which has from 2 to 40 carbon atoms and may be R¹-substituted or unsubstituted, an R¹-substituted or unsubstituted vinylene unit, an acetylene unit or a combination of from 2 to 5 of these systems; the aromatic units may also be part of a larger fused system; the possible substituents R¹ may optionally be situated at any free position;
R¹ is the same or different at each instance and is a straight-chain, branched or cyclic alkyl or alkoxy chain having from 1 to 22 carbon atoms, in which one or more nonadjacent carbon atoms may also be replaced by —NR²—, —O—, —S—, —CO—O—, —O—CO—O—, in which one or more hydrogen atoms may also be replaced by fluorine, or is an aryl or aryloxy group having from 5 to 40 carbon atoms, in which one or more carbon atoms may also be replaced by O, S or N, and which may also be substituted by one or more nonaromatic R¹ radicals, a vinyl or acetylene group or F, Cl, Br, I, NO₂, CN, N(R²)₂, B(R²)₂, Si(R²)₃, and two or more R¹ radicals together may also form an aliphatic or aromatic, mono- or polycyclic ring system;
R² is the same or different at each instance and is H, a straight-chain, branched or cyclic alkyl chain having from 1 to 22 carbon atoms, in which one or more nonadjacent carbon atoms may also be replaced by —O—, —S—, —CO—O—, —O—CO—O—, and in which one or more hydrogen atoms may also be replaced by fluorine, or is an aryl group having from 5 to 40 carbon atoms, in which one or more carbon atoms may also be replaced by O, S or N and which may also be substituted by one or more nonaromatic R² radicals;
   two or more R² radicals together may also form a ring system;
n is the same or different at each instance and is 0, 1, 2, 3 or 4, with the proviso that n must not be 4 when there is a linkage to the polymer chain (i.e. X) at this phenyl unit, and that n must not be 3 or 4 when both linkages to the polymer chain (i.e. X) are on this phenyl unit;
X describes the linkage of the unit to the conjugated polymer,
   and/or of the formula (II) 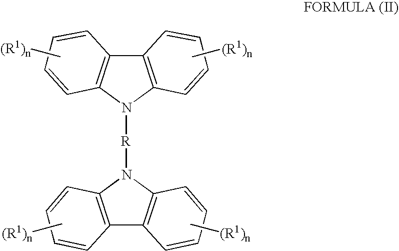
   where the symbols R, R¹, R² and the indices n are each as defined under formula (I).

One embodiment of the invention is of mixtures BLEND1 containing
(A) 5-99.5% by weight of at least one conjugated polymer POLY1 which contains 1-100 mol %, preferably 10-100 mol %, more preferably 20-100 mol %, of one or more units of the formula (I) 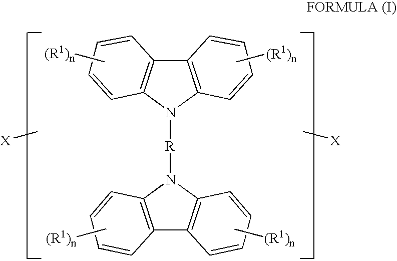
   where the symbols and indices are each defined as described above;
   and
(B) 0.1-95%. by weight, preferably 0.5-80% by weight, more preferably 1-50% by weight, in particular 2-25% by weight, of one or more triplet emitters (COMP1).

In the embodiment BLEND 1, the triplet emitter (COMP1) is mixed in a noncovalent manner with the polymer POLY1.

A preferred embodiment is the incorporation of the units of the formula (I) into the polymer via the 3,6- or the 2,7-position of a carbazole unit (X=linkage), so that one of the two carbazole units is incorporated into the side chain, while, the other constitutes a side chain of the polymer.

A further preferred embodiment is the incorporation of the units of the formula (I) into the polymer via the 2,2′-, the 3,3′- or the 2,3′-positions of the two carbazole units (X=linkage) if R describes an aromatic or heteroaromatic unit, a vinylene or acetylene unit or a combination of these units. In this case, both carbazole units are incorporated into the main chain of the polymer.

A further preferred embodiment is the incorporation (X=linkage) of the units of the formula (I) into the polymer via R itself or via R¹ when it contains aromatic or heteroaromatic units, so as to form a conjugated polymer. In this case, both carbazoles form side chains of the polymer. The linkage may also be via a phenyl ring of a carbazole unit, for example via positions 1 and 4 or 1 and 2. For clarity, the numbering of the carbazole is shown in the following structure; the positions indicated with a prime in the text represent the corresponding atoms on the other carbazole unit in each case:

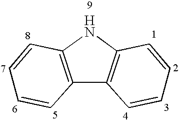

A further embodiment of the invention is of mixtures BLEND2 containing
(A) 0.5-99% by weight of at least one conjugated polymer POLY2 which contains, in covalently bonded form, 0.1-100 mol %, preferably 0.5 to 80 mol %, of one or more triplet emitters (COMP2),
   and
(B) 1-99.5% by weight of a compound of the structural unit of the formula (II) 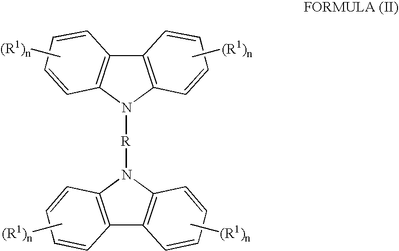
   where the symbols and indices are each as defined as described above.

A preferred embodiment BLEND2 consists in the triplet emitter being incorporated into the main chain and/or into the side chain of the polymer POLY2.

A further aspect of this invention is of mixtures BLEND3 containing
(A) 0.5-98.5% by weight of any conjugated polymer POLY3;
   and
(B) 1-99% by weight, preferably 10-90% by weight, of at least one structural unit of the formula (II) 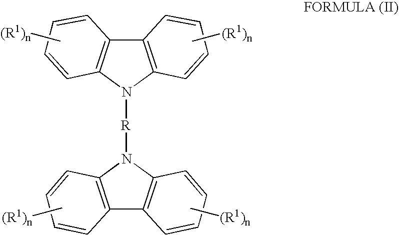
   where the symbols and indices are each as defined above;
      and
(C) 0.1-95% by weight, preferably 0.5-80% by weight, more preferably 1-50% by weight, in particular 2-25% by weight, of one or more triplet emitters (COMP1).

A further aspect of this invention is of mixtures BLEND4 containing.
(A) 0.5-98.5% by weight of any conjugated polymer POLY3 or a plurality thereof;
   and
(B) 1.5-99.5% by weight of a compound COMP3 which contains one or more triplet emitters bonded covalently to at least one structural unit of the formula (II) 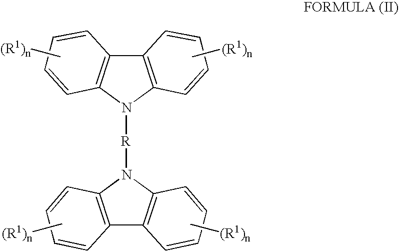
where the symbols and indices are each as defined above and the bond between the triplet emitter and the structural unit of the formula (II) may be at any positions in the triplet emitter and in the structural unit of the formula (II).

Useful triplet emitters (COMP1 or COMP3) are, as mentioned above, also dendrimers. In this context, this should be understood to mean a highly branched compound which is composed of a multifunctional center (core) to which branched monomers are bonded in a regular structure, so as to form a treelike structure. Both the center and the monomers may assume branched structures which consist of purely organic units, organometallic compounds or coordination compounds. Dendrimer should be understood here in a general sense, as described, for example, in M. Fischer, F. Vögtle, Angew. Chem. Int. Ed. 1999, 38, 885-905.

In the context of this invention, conjugated polymers are polymers which contain mainly sp²-hybridized (or partially also sp-hybridized) carbon atoms which may also be replaced by corresponding heteroatoms. In the simplest case, this means alternating presence of double and single bonds in the main chain. “Mainly” means that defects which occur naturally (without further action) and lead to interruptions in conjugation do not invalidate the term “conjugated polymer”. Furthermore, this application text likewise refers to polymers as conjugated when arylamine units, for example the carbazole dimer of the formula (I) or other such units and/or certain heterocycles (i.e. conjugation via N, O or S atoms) and/or organometallic complexes, for example units according to COMP2 (i.e. conjugation via the metal atom) are present in the main chain. In contrast, units such as simple (thio)ether bridges, alkylene chains, ester, amide or imide linkages, for example, would be defined unambiguously as nonconjugated segments.

Apart from the structural units of the formula (I) (in POLY1) and the triplet emitter COMP2 (in POLY2), the polymers POLY1, POLY2 and POLY3 may contain various further structural elements. These include those as already disclosed in the abovementioned patent applications. Reference should also be made here in particular to the relatively comprehensive list in WO 02/077060; this is considered as a constituent of the present invention by reference. These structural units may stem, for example, from the classes described in the following:

1. Structural units which can form the polymer backbone:
Mention should be made here first of phenylenes and structures derived therefrom. These are, for example, (in each case substituted or unsubstituted) ortho-, meta- or para-phenylenes, 1,4-naphthylenes, 9,10-anthracenylenes, 2,7-phenanthrylenes, 1,6- or 2,7- or 4,9-pyrenes or 2,7-tetrahydropyrenes. Also useful are corresponding heterocyclic polyarylene-forming structures, for example 2,5-thiophenylene, 2,5-pyrrolylene, 2,5-furanylene, 2,5-pyridylene, 2,5-pyrimidinylene or 5,8-uinolinylene.
In addition, more complex units such as the abovementioned fluorenes, spiro-9,9′-bifluorenes, multiply bridged units (for example subsegments of the abovementioned L-PPP polymers), but also “double fluorene” units (indenofluorenes). These too may be substituted or unsubstituted. Also useful here are corresponding heterocyclic structures in which, for example, individual ring carbon atoms are replaced by heteroatoms, for example sulfur or nitrogen.

2. Structural units which influence the charge injection and charge transport properties:
This may relate both to the electron injection or transport properties (for example oxadiazole units) and to the hole injection or transport properties (for example triarylamine units). Reference is made here once again to the comprehensive list of such structural units in the above-cited application document WO 02/077060. Equally useful for this purpose are naphthylarylamines, as described in the application document DE 10249723.0 which had not been published at the priority date of this application, or carbazoles, as described in the application document DE 10304819.7 which had not been published at the priority of this application.

The polymers POLY1, POLY2 and POLY3 are homopolymers or are copolymers. The copolymers may have random or partly random, alternating or else blocklike structures, or else have a plurality of these structures in alternation. They may likewise have a linear, branched or dendritic structure. The use of a plurality of different structural elements allows properties such as solubility, solid phase morphology, etc. to be adjusted.

The polymers POLY1, POLY2 and POLY3 generally have from 10 to 10 000, preferably from 50 to 5000, more preferably from 50 to 2000, repeat units. The polydispersity PD is preferably less than 10, more preferably less than 5.

The necessary solubility of the polymers is achieved in particular by virtue of the substituents R¹ on the different monomer units in corresponding polymers.

The polymers POLY1, POLY2 and POLY3 are prepared generally by polymerization of one or more monomers.

There are in principle many appropriate polymerization reactions. However, some types in particular have been found to be useful, which lead to C—C bond formations (SUZUKI coupling, YAMAMOTO coupling, STILLE coupling) or to C—N bond formations (HARTWIG-BUCHWALD coupling). How the polymerization can be carried out by these methods and how the polymers can then be removed from the reaction medium and purified is described in detail, for example, in DE 10249723.0.

In order to be able to prepare the corresponding polymers POLY1, POLY2 and POLY3, the corresponding monomers, as described, are required.

The synthesis of possible comonomers is described in detail in the application documents and patents already mentioned above. A good overview thereof is given by the application document WO 02/077060.

The structural unit of the formula (I) is part of POLY1. It has been found that a content in the range of 10-99 mol % of structural units of the formula (I) achieves good results here. For POLY1 and BLEND1, preference is thus given to a content of 10-99 mol % of structural units of the formula (I). Particular preference is given to a content of 20-99 mol % of structural units of the formula (I).

The structural unit of the formula (II) is part of BLEND2 and BLEND3. It has been found that a content in the range of 5-99% by weight of structural units of the formula (II) achieves good results here. For BLEND2 and BLEND3, preference is thus given to a content of 5-99% by weight of structural units of the formula (II). Particular preference is given to a content of 10-99% by weight of structural units of the formula (II), very particular preference to a content of 20-99% by weight.

A further preferred embodiment is the mixing of structural units of the formula (II) into BLEND1, so that bridged carbazole units are present here both in covalently bonded form and mixed in. It has been found here that a total content of 10-99 mol % of structural units of the formula (I) or formula (II) achieves good results, irrespective of whether these units are bonded covalently to the conjugated polymer or mixed in. Preference is thus given here to a total content of 10-99 mol % of structural units of the formula (I) and (II). Particular preference is given to a total content of 20-99 mol % of structural units of the formula (I) and (II).

A further preferred embodiment is the mixing of structural units of the formula (II) into BLEND4, so that the carbazole dimer units are present here both covalently bonded to the triplet emitter and mixed in. Here too, it has been found that a total content of 10-99 mol % of structural units of the formula (II) achieves good results, irrespective of whether these units are bonded covalently to the triplet emitter or are mixed in. Preference is thus given here to a total content of 10-99 mol % of structural units of the formula (II). Particular preference is given to a total content of 20-99 mol % of structural units of the formula (II).

For preferred structures of the formula (I):
R is the same or different at each instance and is a straight-chain, branched or cyclic alkylene chain which has from 2 to 20 carbon atoms and may be R¹-substituted or unsubstituted, in which one or more nonadjacent carbon atoms may also be replaced by —NR²—, —O—, —S—, —CO—O—, —CO—NR²— or —O—CO—O—, ambivalent aromatic or heteroaromatic ring system selected from thiophene, benzothiophene, benzene, biphenyl, pyridine, quinoxaline, fluorene, spirobifluorene, naphthalene, anthracene, pyrene, phenanthrene, dihydrophenanthrene which bears from 0 to 4 substituents R¹ at the free positions, a stilbenylene or tolanylene system which bears from 0 to 4 substituents R¹ at the free positions, or combinations of from 2 to 5 of these systems;
R¹, R², n are analogous to the statements made above;
   the linkage in POLY1 is preferably via the 3,6- or 2,7-position, via the 2,2′- or 3,3′ position when R is an aromatic or heteroaromatic unit or a stilbenyl or tolanyl unit, or via the R or R¹ group when R or R¹ is an aromatic or heteroaromatic unit or a stilbenyl or tolanyl unit, so that there is an even number of aromatic atoms between the points of linkage.

For particularly preferred structures of the formula (I):
R is the same or different at each instance and is a straight-chain or branched alkylene chain which has from 2 to 15 carbon atoms and may be R¹-substituted or unsubstituted, in which one or more nonadjacent carbon atoms may be replaced by —NR²—, —O— or —S—, a bivalent aromatic or heteroaromatic ring system selected from thiophene, benzothiophene, benzene, biphenyl, naphthalene, anthracene, pyrene or phenanthrene which may be unsubstituted or substituted by one or two substituents R¹, a 9,9′-substituted fluorene, a spirobifluorene which is unsubstituted or substituted by up to four substituents R¹, a 9,10- or 9,9,10,10-substituted dihydrophenanthrene, a stilbenyl or tolanyl system which bears from 0 to 2 substituents R¹ at the free positions, or combinations of from 2 to 4 of these systems;
R¹, R² are analogous to the statements made above;
n is the same or different at each instance and is 0, 1 or 2;
   the linkage with POLY1 is more preferably via the 3,6- or the 2,7-position, the 3,3′-position when R is an aryl, heteroaryl, stilbenyl or tolanyl system, or via the R or R¹ group, when R or R¹ is an aromatic or heteroaromatic unit or a stilbenyl or tolanyl unit, so that the number of the aromatic carbon atoms between the points of linkage is a multiple of four.

Particularly preferred structural units of the formula (I) are substituted or unsubstituted structures of the formulae (III) to (XXXVIII) depicted, the single bonds indicating the linkage in the polymer. They are not intended here to represent methyl groups. For better comparability, potential substituents are not depicted.

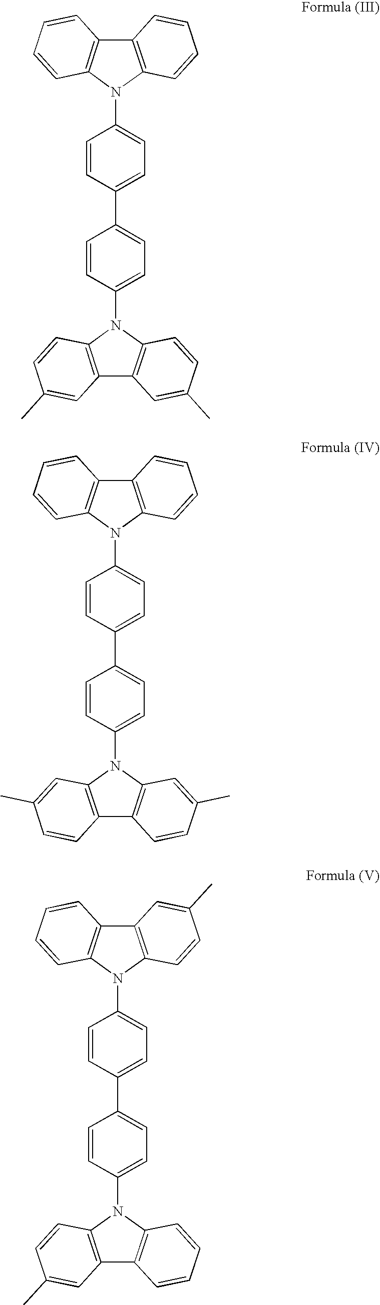

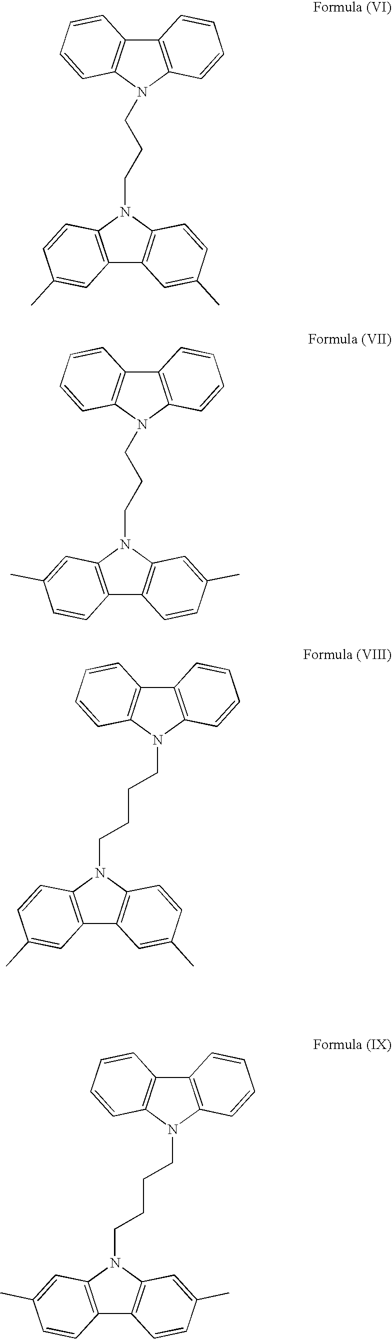

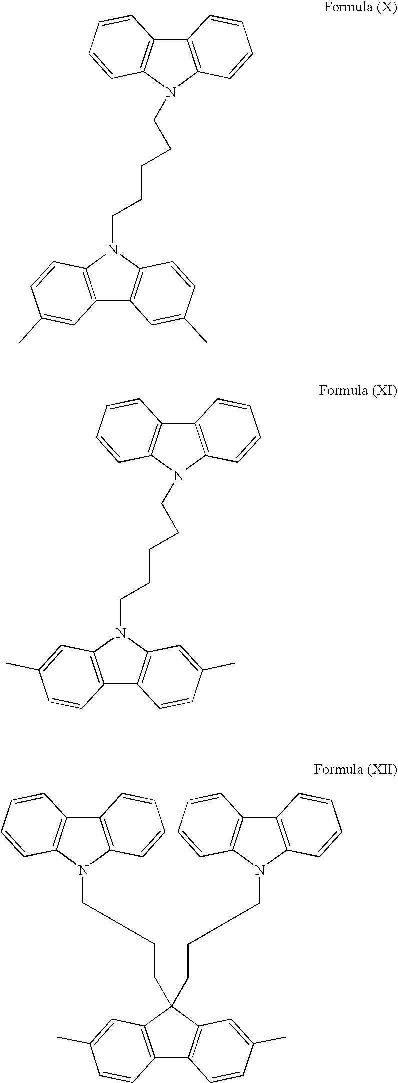

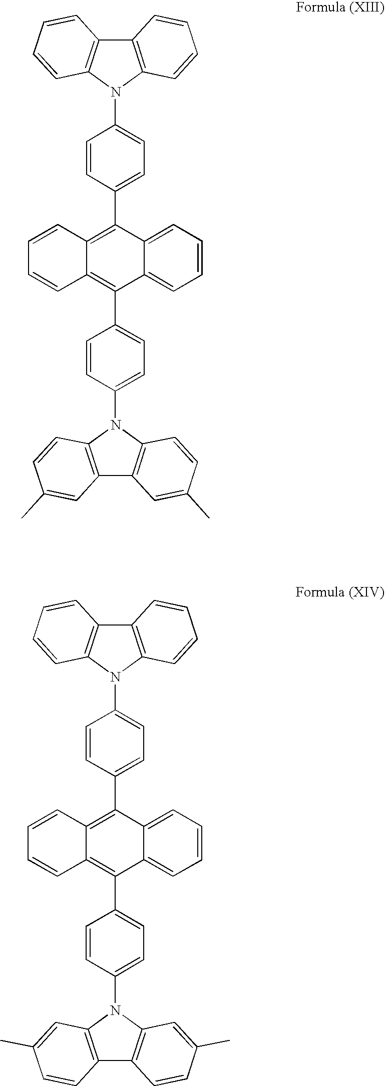

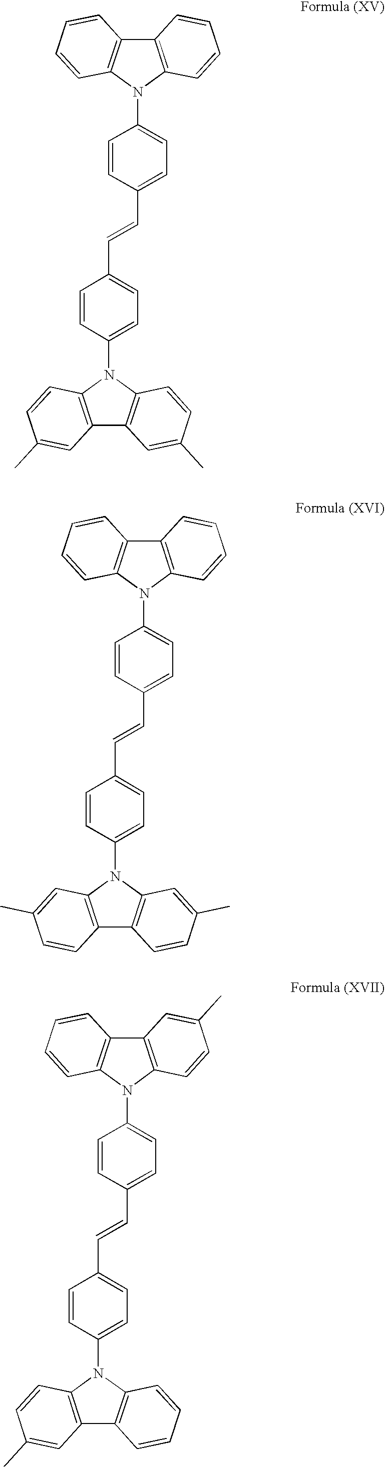

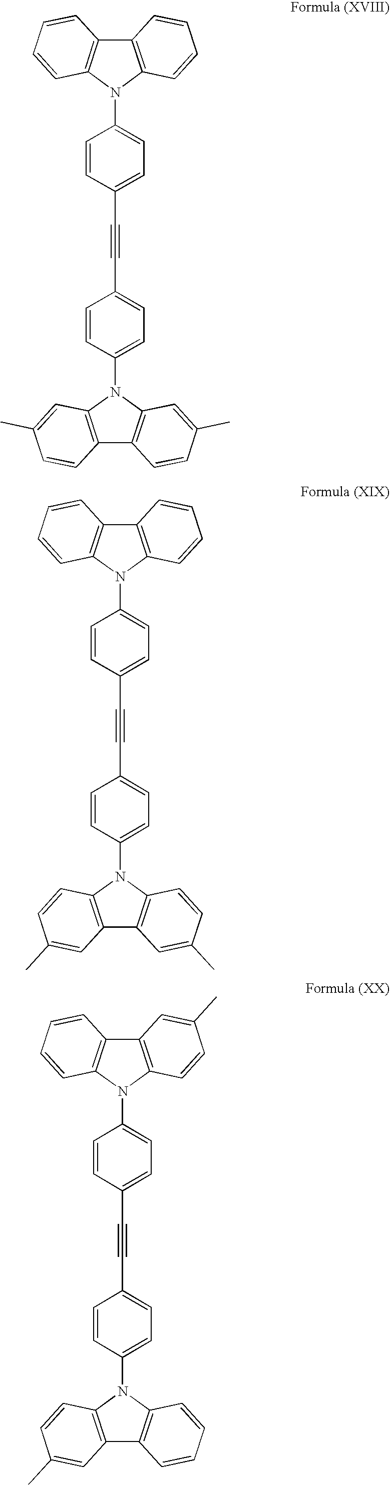

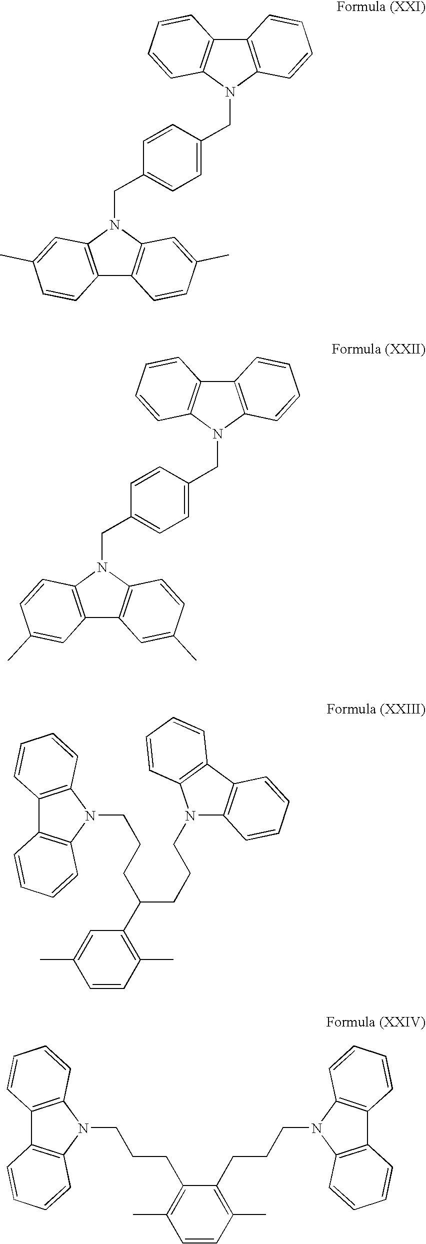

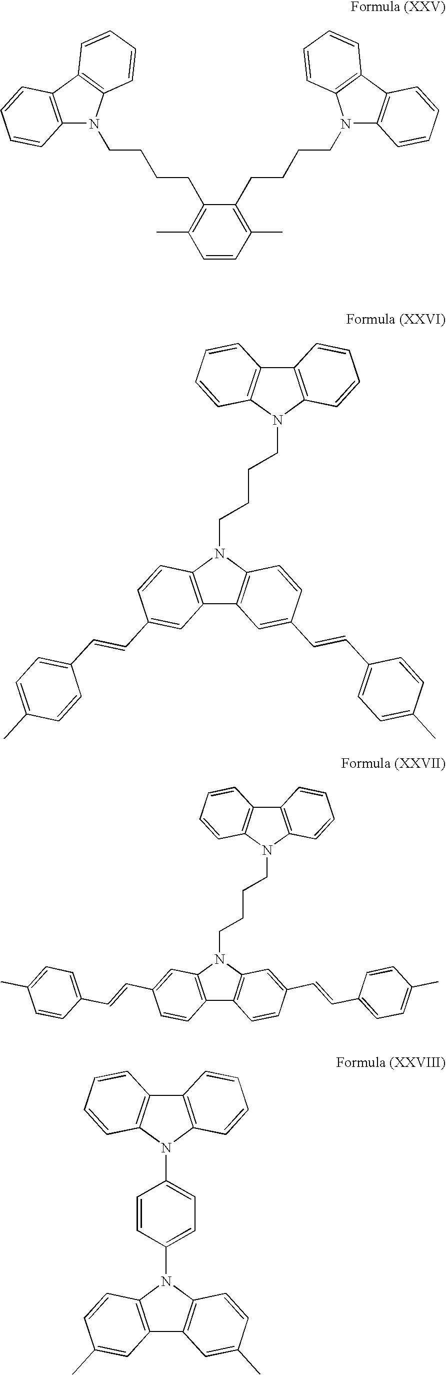

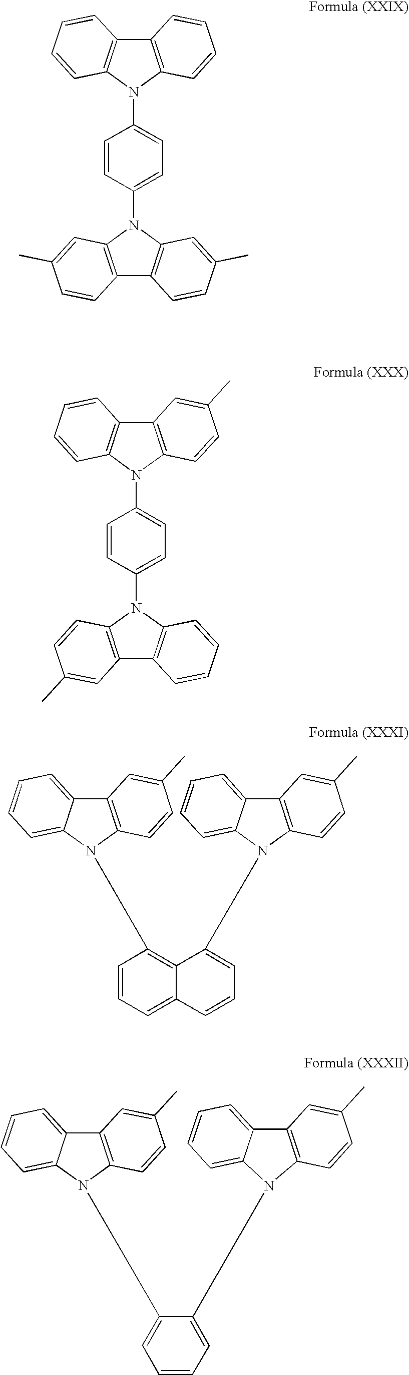

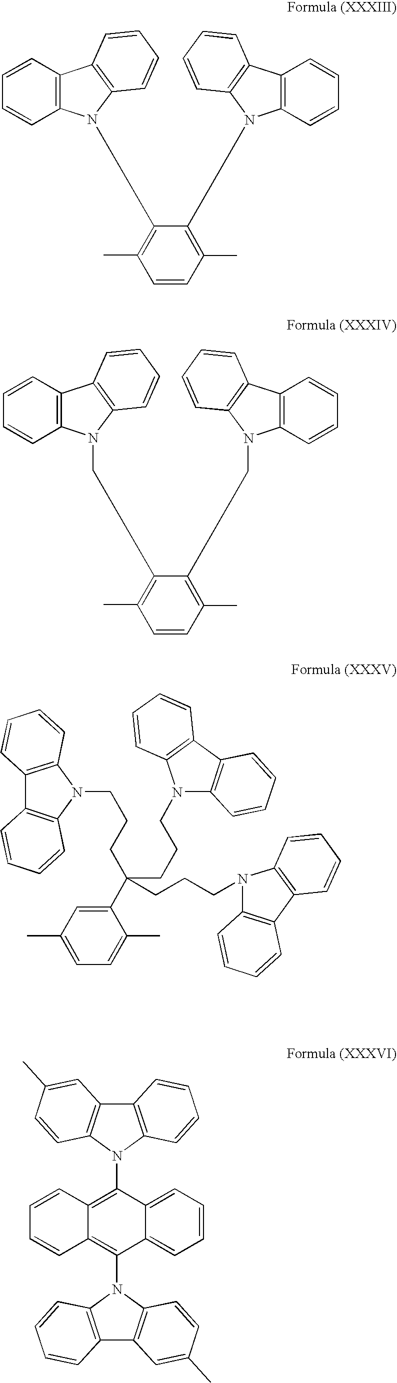

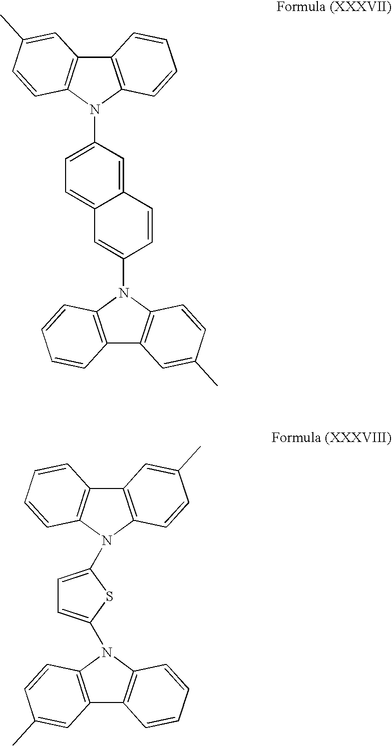

For very particularly preferred structures of the formula (I):
R is the same or different at each instance and is a straight-chain or branched alkylene chain which has from 3 to 10 carbon atoms and may be unsubstituted or R¹-substituted, in which one or more nonadjacent carbon atoms may also be replaced by —N—R²—, —O— or —S—, a bivalent aromatic or heteroaromatic ring system selected from thiophene, benzene, biphenyl, naphthalene, anthracene or phenanthrene, each of which is unsubstituted or substituted by one or two substituents R¹, a 9,9′-substituted fluorene, a spirobifluorene substituted by from 0 to 4 substituents R¹, a 9,10- or 9,9,10,10-substituted dihydrophenanthrene, a stilbenyl or tolanyl system which bears from 0 to 2 substituents R¹ at the free positions, or combinations of 2 or 3 of these systems;
R¹, R², n are analogous to the statements made above;
   the linkage in POLY1 is analogous to the remarks made above.
   For preferred structures of the formula (II):
R is the same or different at each instance and is a straight-chain, branched or cyclic alkylene chain which has from 2 to 20 carbon atoms and may be R¹-substituted or unsubstituted, in which one or more nonadjacent carbon atoms may also be replaced by —NR²—, —O—, —S—, —CO—O—, —CO—NR²— or —O—CO—O—, a bivalent aromatic or heteroaromatic ring system selected from thiophene, benzothiophene, benzene, biphenyl, pyridine, quinoxaline, fluorene, spirobifluorene, naphthalene, anthracene, pyrene, phenanthrene, dihydrophenanthrene which bears from 0 to 4 substituents R¹ at the free positions, a stilbenyl or tolanyl system which bears from 0 to 4 substituents R¹ at the free positions, or combinations of from 2 to 5 of these systems;
R¹, R², n are analogous to the statements made above.

For particularly preferred structures of the formula (II):
R is the same or different at each instance and is a straight-chain or branched alkylene chain which has from 2 to 15 carbon atoms and may be R¹-substituted or unsubstituted, in which one or more nonadjacent carbon atoms may be replaced by —NR²—, —O— or —S—, a bivalent aromatic or heteroaromatic ring system selected from thiophene, benzothiophene, benzene, biphenyl, pyridine, naphthalene, anthracene, pyrene or phenanthrene which may be unsubstituted or substituted by one or two substituents R¹, a 9,9′-substituted fluorene, a spirobifluorene which is unsubstituted or substituted by up to four substituents R¹, a 9,10- or 9,9,10,10-substituted dihydrophenanthrene, a stilbenyl or tolanyl system which bears from 0 to 2 substituents R¹ at the free positions, or combinations of from 2 to 4 of these systems;
R¹, R² are analogous to the statements made above;
n is the same or different at each instance and is 0, 1 or 2.

Particularly preferred structural elements of the formula (II) are substituted or unsubstituted structures of the formulae (XXXIX) to (LVIII) depicted. For better comparability, potential substituents are generally not depicted.

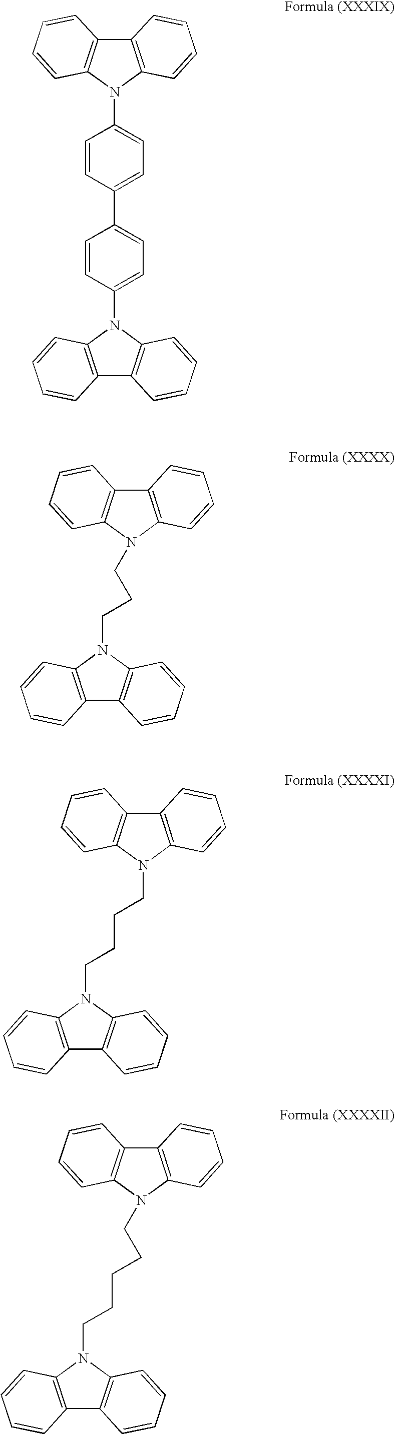

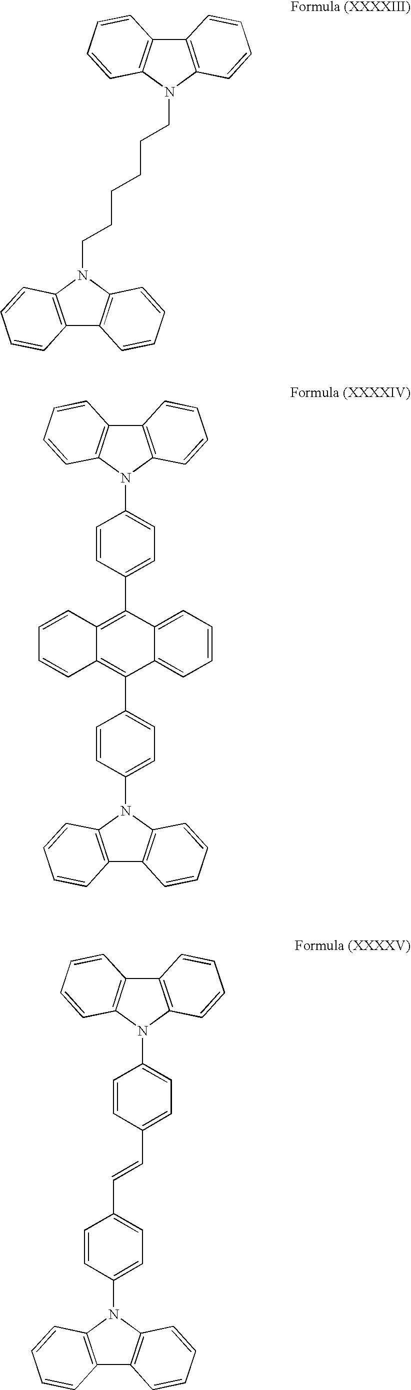

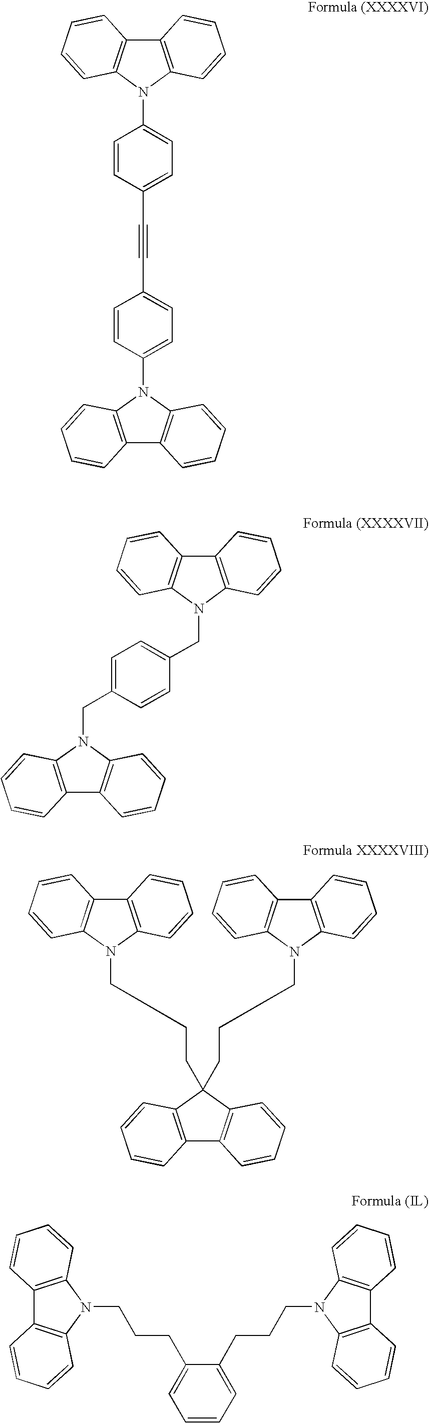

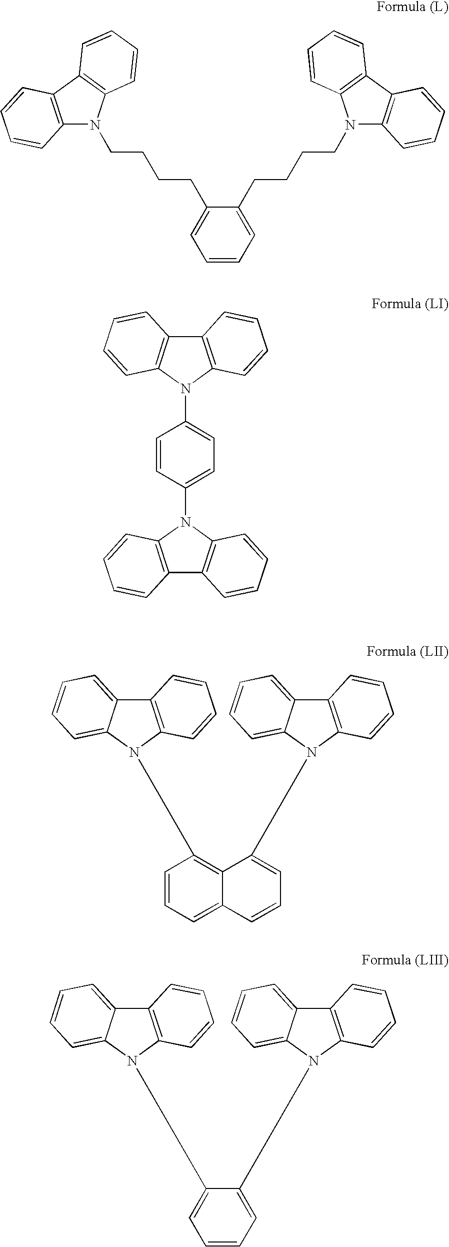

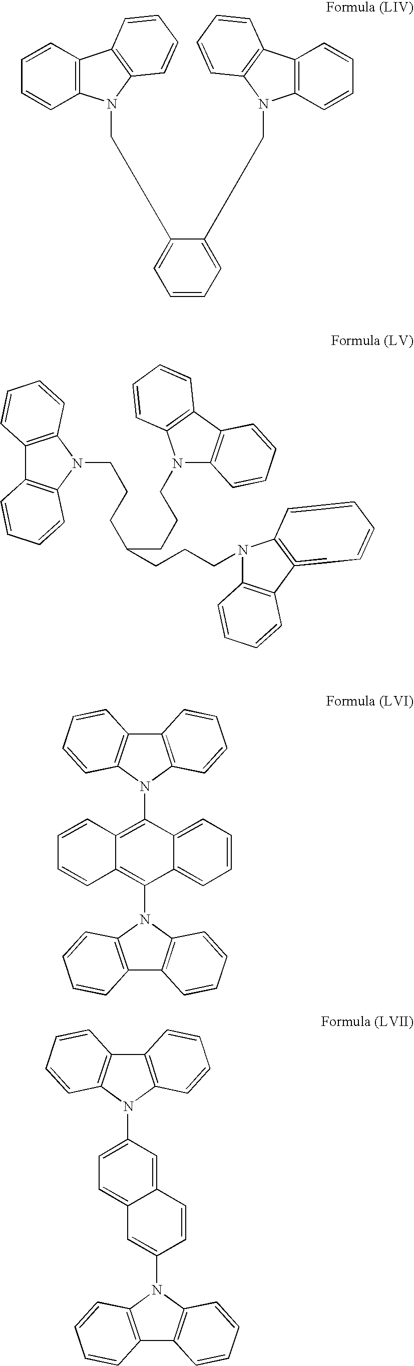

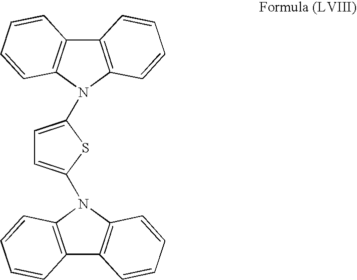

For very particularly preferred structures of the formula (II):
R is the same or different at each instance and is a straight-chain or branched alkylene chain which has from 3 to 10 carbon atoms and may be unsubstituted or R¹-substituted, in which one or more nonadjacent carbon atoms may also be replaced by N—R²—, —O— or —S—, a bivalent aromatic or heteroaromatic ring system selected from thiophene, benzene, biphenyl, naphthalene, anthracene or phenanthrene, each of which is unsubstituted or substituted by one or two substituents R¹, a 9,9′-substituted fluorene, a spirobifluorene substituted by from 0 to 4 substituents R¹, a 9,10- or 9,9,10,10-substituted dihydrophenanthrene, a stilbenyl or tolanyl system which bears from 0 to 2 substituents R¹ at the free positions, or combinations of 2 or 3 of these systems;
R¹, R², n are analogous to the statements made above.

Even though this is evident from the description, it is once again explicitly pointed out here that both the structural units of the formula (I) and (II) and those of the formulae (III) to (LVIII) may be unsymmetrically substituted, i.e. that different substituents R¹ may be present on one unit, or they may also be bonded at different positions.

Structural units of the formula (II) which are used- in BLEND2 and BLEND4 may be obtained, for example, as described below:
The N-alkylation or N-benzylation of carbazoles is known in the literature. In this way, it is also possible for two carbazole units to be bridged with a substituted or unsubstituted alkylene, benzyl, alkylarylene or cycloalkylene chain. The synthesis is effected by reacting the carbazole with an alkylating agent under basic conditions, as described, for example, in: M. E. Wright et al., J. Org. Chem. 1989, 54, 965.
Carbazole can be N-arylated according to HARTWIG-BUCHWALD and is described for carbazole, for example, in: M. Watanabe et al., Tetrahedron Lett. 2000, 41, 481. It is equally possible by this method for two carbazole units to be bridged by appropriate arylene, heteroarylene, stilbenylene or tolanylene groups.
The synthesis of carbazoles which bear alkyl substituents on the carbazole parent structure is known in the literature: P. Bhattacharyya et al., J. Chem. Soc., Chem. Commun. 1984, 1668.
Further substitutions on the carbozole parent structure can be obtained starting from the halogen compounds described below. This allows further organic radicals to be introduced, for example by palladium-catalyzed cross-coupling reactions. It is equally possible for compounds composed of carbazole dimers and triplet emitters (COMP3), as required for BLEND4, to be obtained by analogous reactions with appropriately substituted triplet emitters.

For the synthesis of POLY1, the appropriate monomers which lead to structural units of the formula (I) in the polymer may be obtained, for example, as described below:
3,6-Dibromocarbazole is synthesized by brominating carbazole, as described in the literature: Smith et al., Tetrahedron 1992, 48, 7479.
2,7-Dibromocarbazole is synthesized by constructing the carbazole parent structure, as described in the literature: Tidwell et al., Eur. J. Med. Chem. 1997, 32, 781.
   An appropriate functionalization which enables use as a monomer (i.e., for example, introduction of halogen end groups) can in principle be effected either on the precursors or as the last step on the already fully constructed parent structure.
   The functionalities may already be present in advance when they only react in a very impaired manner, if at all, in subsequent reaction steps. This may, for example, be the case in a simple substitution reaction, or when different reactivities (for example iodine relative to bromine or bromine relative to chlorine) can be utilized.
   Secondly, it may also be advantageous (in the event, for example, of existing substitution or directing radicals) first to construct the bridged carbazole parent structure and to introduce the halogen functionality in a last step. For example, it is thus possible to introduce bromine into the 3- and 6-positions of a carbazole unit (for example by mild NBS bromination, e.g. Creason et al., J. Org. Chem. 1972, 37, 4440) when the second carbazole unit is blocked by substituents. As outlined above, this process may also be employed for further structures of the formula (I) in the presence of (i) corresponding blocked substituents, (ii) appropriately directing radicals or (iii) activated or deactivated heterocycles. Equally possible is a functionalization in the 6,6′-position when the 3,3′-positions are already blocked by other substituents.
   It is possible from the halogen derivatives to prepare via standard processes corresponding bisboronic acid derivatives or bisstannane derivatives (for the abovementioned polymerization processes of types A and C). These processes generally consist in exchanging the halogen present for a metal (e.g. Mg, Li) and reacting it with a boric ester or a trialkyltin halogen compound. For the preparation of boronic acid derivatives, catalytic processes for the direct reaction of the halides with, for example, boranes or diboranes under palladium catalysis are also known.

The invention further provides bifunctional monomeric compounds of the formula (LIX) 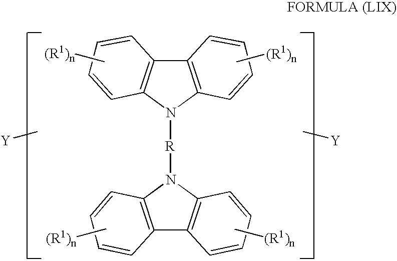
characterized in that the two functional groups Y are the same or different and copolymerize under conditions for C—C or C—N bond formations; the further symbols and indices are each as defined in formula (I); the linkage of Y is to the same positions as for X for formula (I).

Y is preferably selected from the groups of Cl, Br, I, O-tosylate, O-triflate, OSO₂R², B(OH)₂, B(OR²)₂, Sn(R²)₃ and NHR², where R² is as defined as described above.

The C—C and C—N bond formations are preferably selected from the groups of the SUZUKI coupling, the YAMAMOTO coupling, the STILLE coupling and the HARTWIG-BUCHWALD coupling.

Especially preferred here are monomeric compounds of the formula (LIX) which lead in the polymer to structural units of the formula (III) to (XXXVIII).

The structural units COMP1 mixed into BLEND1 and BLEND3, the structural units COMP2 polymerized into POLY2 (=BLEND2) and the structural units COMP3 mixed into BLEND4 may be selected from any organic or organometallic substance classes which enable transfer of singlet excitons to triple excitons and can also emit light at room temperature from the triplet state: firstly, these are in particular compounds which contain heavy atoms, i.e. atoms from the periodic table of the elements having an atomic number of more than 36. Particularly suitable for this purpose are compounds which contain d and f transition metals which fulfill the abovementioned conditions. Very particular preference is given here to corresponding structural units which contain elements of group 8 to 10 (Ru, Os, Rh, Ir, Pd, Pt). Such compounds are known for all emission colors (blue, green, red).

COMP1 or COMP3 may be a low molecular weight, oligomeric, dendritic or polymeric compound. Since COMP1 or COMP3 has to be processed as a blend (BLEND1, BLEND3, BLEND4), there has to be sufficient solubility in suitable solvents (for example toluene, xylene, anisole, THF, methylanisole, methylnaphthalene or mixtures of these solvents) so that processing from solution is possible in these solvents. Useful low molecular weight structural units here are, for example, various complexes, as described, for example, in WO 02/068435, WO 02/081488, EP 1239526 and WO 04/026886. Useful dendrimer structures for this purpose are complexes as described, for example, in WO 99/21935, WO 01/059030 and WO 02/066552.

COMP2 is incorporated covalently into the polymer chain of POLY2 (=BLEND2). Preference, may be given to incorporation either into the main chain or into the side chain of the polymer. In order to enable the incorporation of COMP2 into POLY2, functional polymerizable groups have to be present on COMP2. Examples of corresponding brominated complexes which can be used as monomers in polymerization reactions are described in WO 02/068435.

The inventive mixture BLEND1 is obtained by adding COMP1 units to the polymer POLY1. The inventive mixture BLEND2 is obtained by adding structural units of the formula (II) to the polymer POLY2. The inventive mixture BLEND3 is obtained by adding structural units of the formula (II) and COMP1 units to the polymer POLY3. The inventive mixture BLEND4 is obtained by adding COMP3 units to the polymer POLY3.

It may also be preferred to mix still further conjugated, part-conjugated or nonconjugated polymers, oligomers, dendrimers or low molecular weight compounds into BLEND1 to BLEND4. For example, addition of an electronically active substance allows the hole or electron injection, the hole or electron transport or the charge equilibrium in the corresponding blend to be regulated. The additive components may also improve the singlet-triplet transfer. However, the addition of electronically inert compounds may also be helpful in order, for example, to control the viscosity of the solution or the morphology of the film.

The thus obtained blends thus also form part of the subject matter of the invention.

The invention further provides conjugated polymers POLY4 containing
(A) 1-99.9 mol %, preferably 10-99 mol %, more preferably 20-99 mol %, of one or more units of the formula (I) 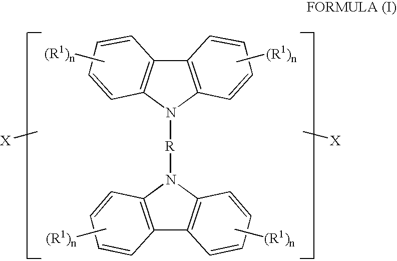
where the symbols X, R, R¹, R² and the indices n are each defined as described above, and
(B) 0.1-95 mol %, preferably 0.5-80 mol %, more preferably 1-50 mol %, in particular 2-25 mol %, of one or more triplet emitters, preferably in the form of one or more organometallic structural units COMP2.

In these polymers, the structural units of the formula (I) are incorporated as described for the polymer POLY1. The structural units COMP2 are incorporated into the main chain and/or side chain of POLY4 as already described for POLY2.

POLY4 may contain further structural elements (for example polymer backbone units, charge injection or transport units), as described for POLY1 to POLY3. It may likewise have a random, partly random, alternating or blocklike structure, and may be linear, branched or dendritic. In POLY4 too, the solubility of the polymer is determined in particular by the substituents R and R¹ on the polymer units. POLY4 is synthesized as described for POLY1 to POLY3. Particularly preferred structural units of the formula (I) are the structures of the formula (III) to (XXXVIII) depicted above.

In addition, preference may be given to mixing still further conjugated, part-conjugated or nonconjugated polymers, oligomers, dendrimers or low molecular weight compounds into POLY4, so that a blend is formed here too. It may be preferred here to mix in structural units of the formula (II), so that the total content of structures of the formula (I) and (II) is increased. Preference may likewise be given to mixing in structural units COMP1. However, the addition of other components may also be found to be viable for some applications. For example, addition of an electronically active substance allows the hole or electron injection, the hole or electron transport or the charge equilibrium of the thus formed blend to be regulated. The additive components may also improve the single-triplet transfer. However, the addition of electronically inert compounds may also be helpful in order, for example, to control the viscosity of the solution or the morphology of the film. The blends thus obtained from POLY4 thus also form part of the subject matter of the invention.

BLEND1 to BLEND4 (or optionally a blend of POLY4 and further components) are prepared as follows: the individual constituents of the blend are combined in a suitable mixing ratio and dissolved in a suitable solvent. Suitable solvents are, for example, toluene, anisole, xylenes, methylanisole, methylnaphthalene, chlorobenzene, cyclic ethers (e.g. dioxane, THF, methyldioxane), amides (e.g. NMP, DMF) and mixtures of these solvents. Alternatively, the constituents of the blend may also be dissolved individually. In this case, the solution of the blend is obtained by combining the individual solutions in a suitable mixing ratio. The dissolution operation preferably takes place in an inert atmosphere. The blend is typically not isolated as a solid (by precipitating again), but rather further processed directly from solution.

A suitable ratio of the individual components is, for example, a mixture which contains a total of 1-99.5 mol %, preferably 10-99 mol %, more preferably 20-99 mol %, of units of the formula (I) and formula (II), and 0.1-95 mol %, preferably 0.5-80 mol %, more preferably 1-50 mol %, in particular 2-25 mol %, of COMP1, COMP2 and COMP3, irrespective of whether the components are bonded covalently to a polymer or mixed in.

The inventive mixtures BLEND1 to BLEND4 and polymers POLY4 have the following surprising advantages, among others, over the abovementioned prior art:
The light emission of the triplet emitter is surprisingly significantly more efficient in inventive polymers POLY1 or blends BLEND1 to BLEND4 than in comparable polymers and blends which do not contain any units of the formula (I) or formula (II) (cf. data in Table 1).
The current at a given voltage for comparable polymers or comparable blends when they are used in PLEDs, i.e. the current-voltage characteristic line is steeper when both a conjugated polymer and structural units of the formula (I) or formula (II) are present (irrespective of whether it is a pure conjugated polymer or a mixture). As already detailed above, this brings distinct advantages for application, since the aim of obtaining efficient full-color displays with low energy consumption is thus enabled.
The solubility in organic solvents is good, i.e., in solvents such as toluene, xylene, anisole, methylanisole, or methylnaphthalene, for example, the mixtures BLEND1 to BLEND4 and the polymers POLY4 are soluble in concentrations in the range from at least 1 to 30g/l (depending on the triple emitter used and the molecular weight of the polymer).

The mixtures BLEND1 to BLEND4 and the polymers POLY4 may be used in PLEDs. For the construction of PLEDs, a general process is generally used and has to be adapted appropriately to the individual case. Such a process has been described in detail, for example, in DE 10249723.0.

As described above, the inventive mixtures BLEND1 to BLEND4 and the inventive polymers POLY4 are very particularly suitable as electroluminescent materials in OLEDs or displays produced in this way. In the context of this invention, electroluminescent materials are regarded as being materials which emit light at an active layer in an OLED on application of an electrical field (light-emitting layer).

The invention therefore also provides for the use of an inventive mixture BLEND1 to BLEND4 or of an inventive polymer POLY4 in an OLED as an electroluminescent material.

The invention likewise provides an OLED having one or more active layers, at least one of these layers comprising one or more inventive mixtures BLEND1 to BLEND4 or inventive polymers POLY4.

In the present application text and also the examples which follow below, the aim is the use of inventive mixtures BLEND1 to BLEND4 and inventive polymers POLY4 in relation to OLEDs and the corresponding displays. In spite of this restriction of the description, it is possible for those skilled in the art without any further inventive activity also to utilize the inventive polymers or blends for further uses in other electronic devices, for example for organic solar cells (O-SCs), nonlinear optics, organic optical detectors or else organic laser diodes (O-laser), to mention just a few applications. These likewise form part of the subject matter of the present invention.

The invention is illustrated in detail by the examples which follow without any intention to restrict it thereto.

### EXAMPLES

Part A: Synthesis of the Monomers and Blend Constituents

### Example A1

### Synthesis of the Monomers for POLY1

The synthesis of the monomers M1 to M23 has already been described in detail in WO 02/077060 and the literature cited therein. For better clarity, the monomers are shown once again below:

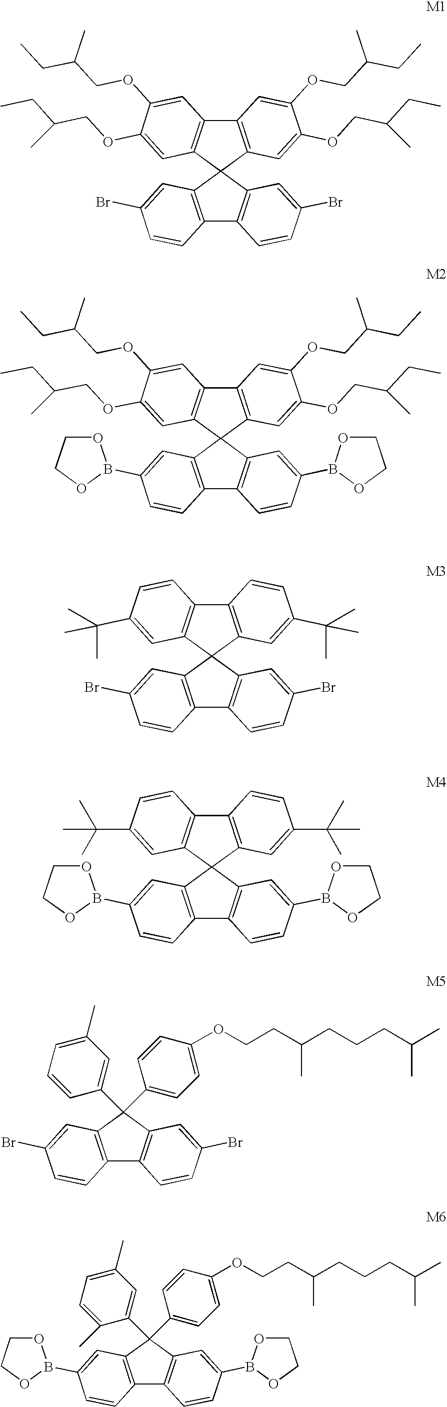

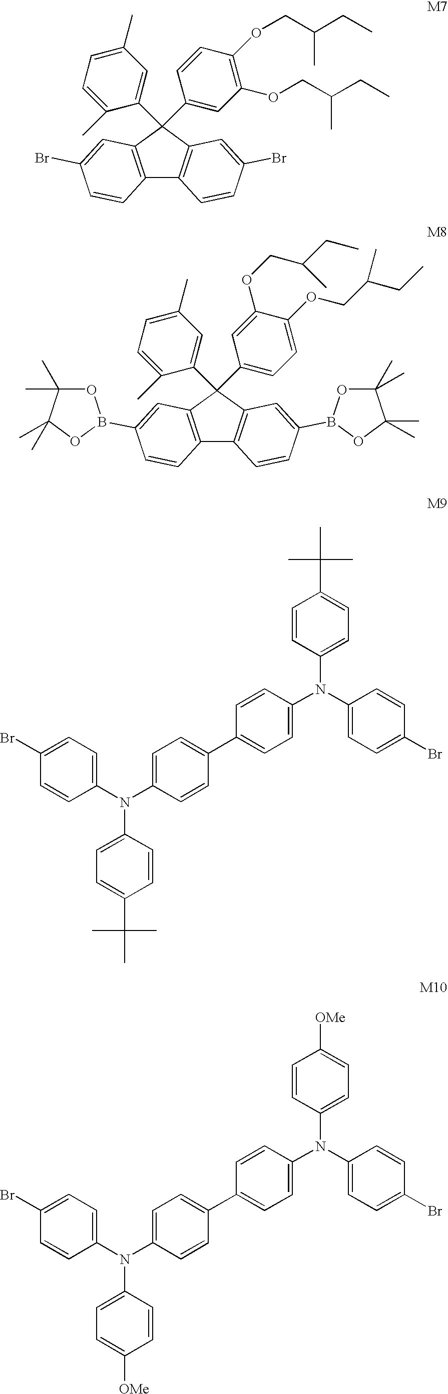

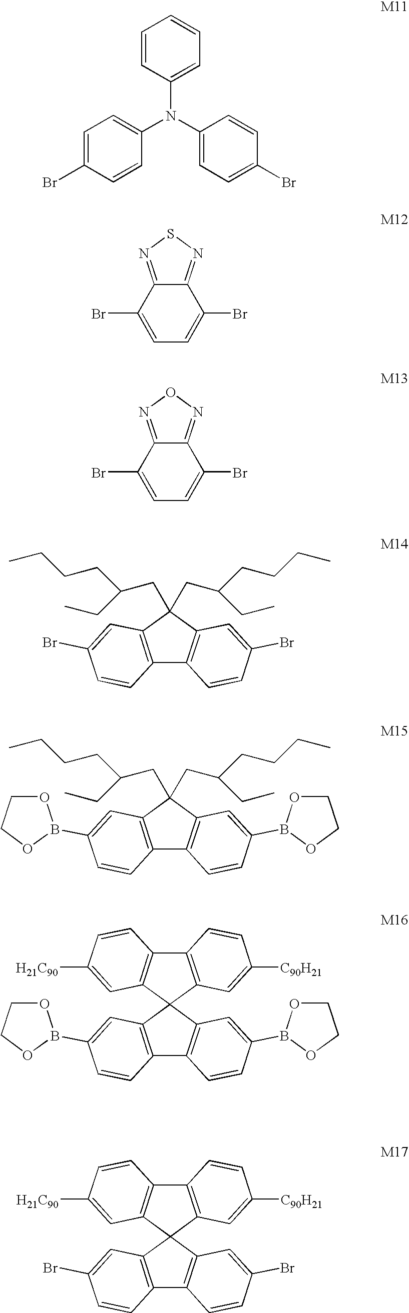

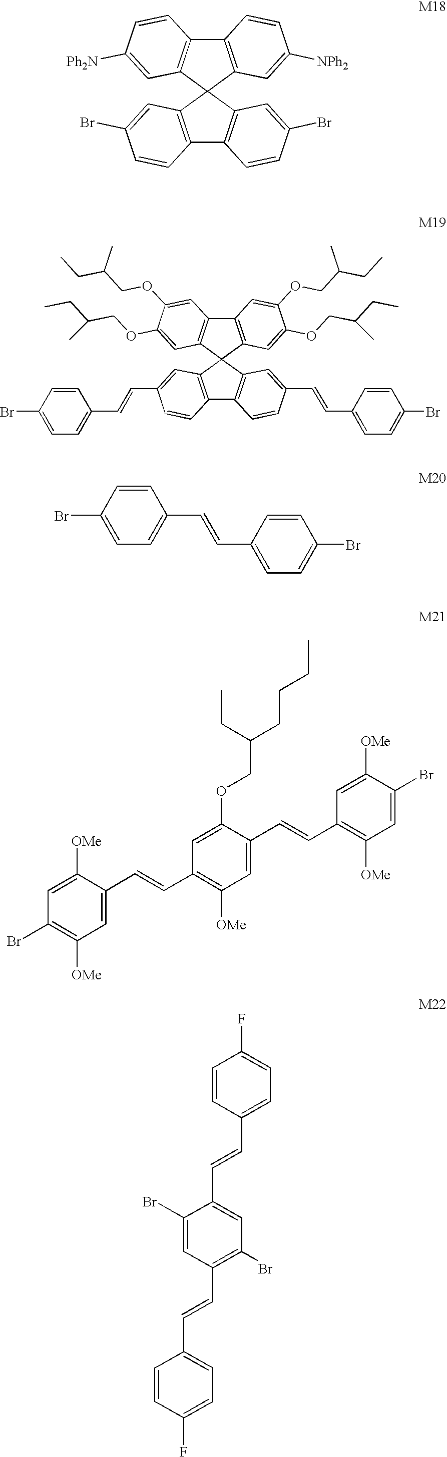

### Example A2

### Inventive Monomers of the Formula (I)

The monomers of the formula (I) are designated below as “IM” (=inventive monomer).

3,6-Dibromocarbazole was synthesized according to Smith et al., Tetrahedron 1992, 48, 7479. 3-Methylcarbazole was synthesized according to P. Bhattacharyya et al., J. Chem. Soc., Chem. Commun. 1984, 1668. The structural integrity of all products was demonstrated by means of ¹H NMR spectroscopy; the purity of the products was determined by means of HPLC.
N-(ω-Bromoalkyl)carbazole: General Description

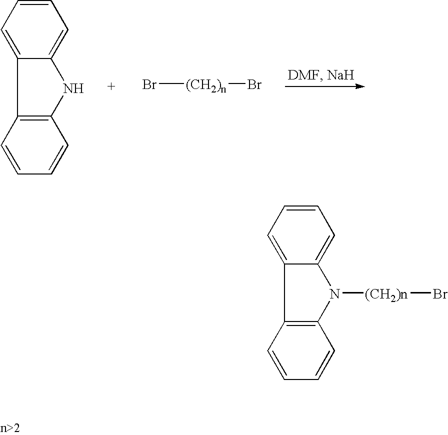

Under protective gas, 44 mmol of sodium hydride are added to a suspension of 40 mmol of carbazole in 100 ml of dry THF. After the evolution of hydrogen is complete, 400 mmol of the appropriate α,ω-dibromoalkane are added through a septum and the mixture is stirred at RT overnight with exclusion of moisture. The sodium bromide which forms is filtered off, THF is removed under reduced pressure and excess bromoalkane is recovered in an oil-pump vacuum. The product is isolated by column chromatography (silica gel/CHCl₃).

N-(3-Bromopropyl)carbazole (n=3): 6.68 g (40 mmol) of carbazole, 80.8 g (40.6 ml, 400 mmol) of 1,3-dibromopropane, 1.06 g (44 mmol) of NaH, 100 ml of THF.

Yield: 9.2 g (56%), HPLC purity 99.4%.

¹H NMR (CDCl₃, 500 MHz): 8.11 (d, J=8.7 Hz, 2H), 7.48 (m, 4H), 7.24 (m, 2H), 4.51 (t, J=6.35 Hz, 2H), 3.39 (t, J=6.35 Hz, 2H), 2.43 (m, 2H).

N-(4-Bromobutyl)carbazole (n=4): 6.68 g (40 mmol) of carbazole, 86.36 g (47.2 ml, 400 mmol) of 1,4-dibromobutane, 1.06 g (44 mmol) of NaH, 100 ml of THF.

Yield: 8.58 g (71%), HPLC purity 99.5%.

¹H NMR (CDCl₃, 500 MHz): 8.11 (d, J=8.7 Hz, 2H), 7.48 (m, 4H), 7.24 (m, 2H), 4.35 (t, J=6.35 Hz, 2H), 3.37 (t, J=6.35 Hz, 2H), 2.43-1.81 (m, 4H).
Monomers from Alkylcarbazole Dimers: General Description

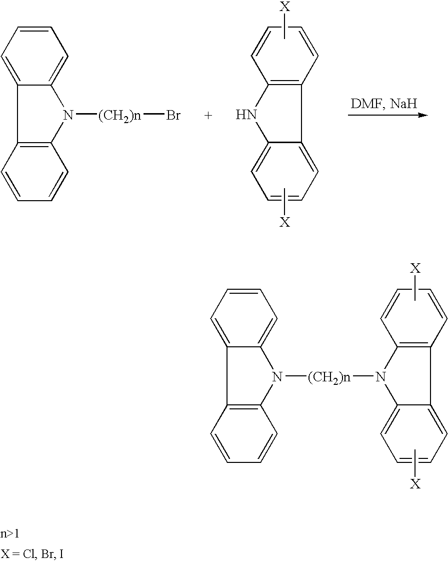

In a 500 ml flask with reflux condenser, 990 mg (41.2 mmol) of sodium hydride are suspended under protective gas in 80 ml of dry DMF. A solution of 30.8 mmol of 3,6- or 2,7-dihalocarbazole (X=Cl, Br, I) in 80 ml of DMF is added dropwise at RT within 20 min to this reaction mixture. Subsequently, a solution of 30.8 mmol of N-(ω-bromoalkyl)carbazole in 50 ml of dry DMF is added dropwise and the mixture is heated to 60° C. for 8 h. After cooling to room temperature, 300 ml of water and 200 ml of ethyl acetate are added cautiously. The phases are separated, the organic phase is washed with 4×50 ml of H₂O and dried over MgSO₄, and the solvents are removed under reduced pressure. The pure product is obtained by repeated recrystallization from n-hexane.

IM1: 3,6-Dibromo-N-(N-carbazolyl)propylcarbazole (X=Br, n=3): 10.0 g (30.8 mmol) of 3,6-dibromocarbazole, 8.9 g (30.8 mmol) of N-3-bromopropyl)carbazole, 0.99 g (41.2 mmol) of NaH, 160 ml of DMF.

Yield: 13.8 g (85%), HPLC purity 99.9%.

¹H NMR (CDCl₃, 500 MHz): 8.12 (m, 4H), 7.45 (d, J=8.7 Hz, 2H), 7.44-7.39 (m, 2H) 7.28-7.20 (d, J=8.7 Hz, 4H), 6.77 (d, J=8.7 Hz, 2H), 4.38 (t, J=7.0 Hz, 2H), 3.23 (t, J=7.36 Hz, 2H), 2.43 (m, 2H).

IM2: 3,6-Dibromo-N-(N-carbazolyl)butylcarbazole (X=Br, n=4): 10 g (30.8 mmol) of 3,6-dibromocarbazole, 9.3 g (30.8 mmol) of N-4-bromobutyl)carbazole, 0.99 g (41.2 mmol) of NaH, 160 ml of DMF.

Yield: 14.6 g (87%), HPLC purity 99.9%.

¹H NMR (CDCl₃, 500 MHz): 8.11 (m, 4H), 7.44 (d, J=8.7 Hz, 2H), 7.43-7.39 (m, 2H), 7.28-7.20 (d, J=8.7 Hz, 4H), 6.77 (d, J=8.7 Hz, 2H), 4.34 (t, J=6.35 Hz, 2H), 3.36 (t, J=6.35 Hz, 2H), 2.42-1.80 (m, 4H).
Fluorenecarbazole Dimers

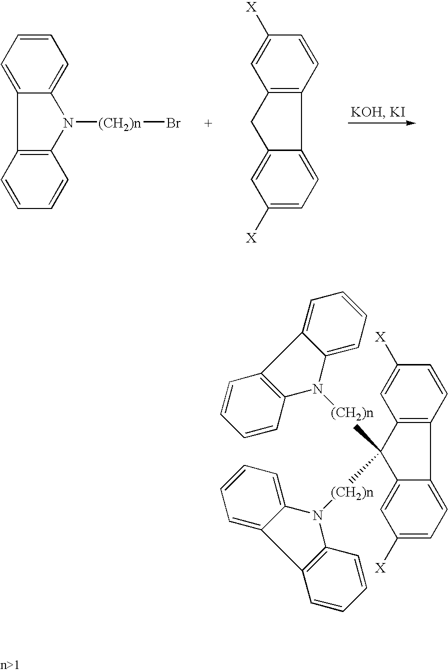

IM3: 2,7-Dibromo-9,9-bis(3-(N-carbazolyl)propyl)fluorene (X=Br, n=3):

Under protective gas, 9.0 g (28 mmol) of 2,7-dibromofluorene, 16.4 g (57 mmol) of N-(3-bromopropyl)carbazole and 0.5 g (3 mmol) of Kl in 56 ml of DMSO were stirred at RT until a clear solution formed. Subsequently, 6.6 g (119 mmol) of KOH were added in portions. After 1 h, the mixture was admixed with 200 ml of water and extracted with CHCl₃. The combined organic phases were washed with water and dried over MgSO₄. Subsequently, the solvent was removed under reduced pressure, and the resulting oil was purified by column chromatography (silica gel, hexane/EA 40:1).

Yield: 15.5 g (76%), HPLC purity: 99.5%.

¹H NMR (CDCl₃, 500 MHz): 8.10 (m, 4H), 7.88 (s, 2H), 7.61 (d, J=7.9 Hz, 2H), 7.55 (d, J=7.9 Hz, 2H), 7.44-7.38 (m, 4H), 7.28-7.17 (m, 8H), 4.30 (t, J=7.02 Hz, 4H), 2.21 (t, J=7.36 Hz, 4H), 1.91 (m, 4H).

IM4: 2,7-Dibromo-9,9-bis(4-(N-carbazolyl)butyl)fluorene (X=Br, n=4):

The synthesis was effected in analogy to the synthesis of EM3. 9.0 g (28 mmol) of 2,7-dibromofluorene, 17.2 g (57 mmol) of N-(4-bromobutyl)carbazole, 0.5 g (3 mmol) of Kl, 6.6 g (119 mmol) of KOH, 56 ml of DMSO.

Yield: 15.4 g (73%), HPLC purity 99.5%.

¹H NMR (CDCl₃, 500 MHz): 8.11 (m, 4H), 7.68 (s, 2H), 7.60 (d, J=7.9 Hz, 2H), 7.43 (d, J=7.9 Hz, 2H), 7.43-7.36 (m, 4H), 7.27-7.15 (m, 8H), 4.35 (t, J=6.35 Hz, 4H), 2.23 (t, J=6.35 Hz, 4H), 1.90-1.31 (m, 8H).

### Biphenylcarbazole

### 4,4′-Bis(3-methylcarbazol-9-yl)biphenyl

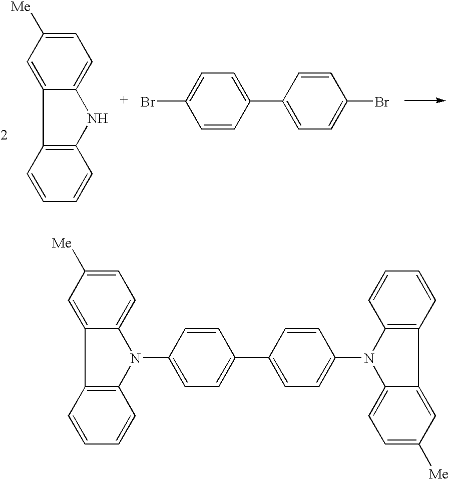

7.5 g (25 mmol) of 4,4′-dibromobiphenyl were initially charged in 95 ml of p-xylene, and the solution was degassed with argon for 30 min. Then, first 20.1 g (150 mmol) of potassium phosphate and subsequently a solution of 0.27 g. (1.5 mmol) of chlorodi^{tert}butylphosphine/0.29 g (3 mmol) of NaO^{tert}Bu/5 ml of p-xylene and, 10 minutes later, 0.11 g (0.5 mmol) of Pd(II) acetate were added. After addition of 18.1 g (100 mmol) of 3-methylcarbazole, the mixture was heated under reflux at 125° C. for 3 days. The mixture was admixed with 120 ml of water and stirred for a few hours. The solid was filtered off with suction, washed with xylene and water and recrystallized from EtOH.

Yield: 21 g (95%), HPLC purity 99.3%.

¹H NMR (CDCl₃, 500 MHz): 8.97 (d, J₄=2.0 Hz, 2H), 8.35 (dd, J₃=9.2 Hz, J₄=2.0 Hz, 2H), 8.12 (d J₃=7.8 Hz, 2H), 7.55 (t, J₃=8.2 Hz, 2H), 7.49 (d, J₃=8.2 Hz, 2H), 7.46 (d, J₃=9.2 Hz, 2H), 7.40 (d, J₃=8.3 Hz, 4H), 7.35 (d, J₃=8.3 Hz, 4H), 7.34 (t, J₃=7.8 Hz, 2H), 2.35 (s, 3H).

### IM5: 4,4′-Bis(3-bromo-6-methylcarbazol-9-yl)biphenyl

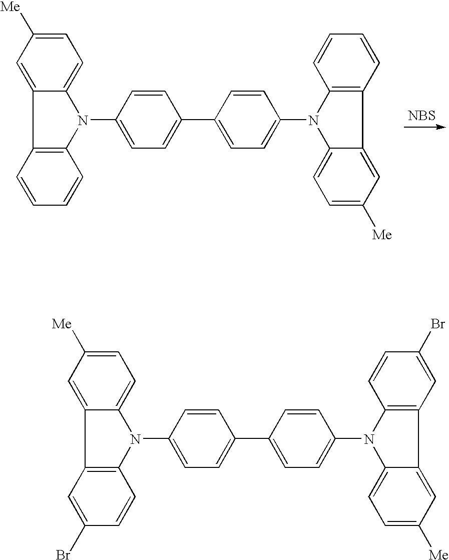

10.25 g (20 mmol) of 4,4′-bis(3-methylcarbazol-9-yl)biphenyl were dissolved in 30 ml of dry acetonitrile. Under protective gas, 7.1 g (40 mmol) of N-bromosuccinimide were added slowly and the mixture was stirred at RT for 21 h. The residue was filtered and washed with a little acetonitrile and subsequently with hot water. The product was purified by recrystallization from dioxane.

Yield: 12 g (90%), HPLC purity 99.3%.

¹H NMR (CDCl₃, 500 MHz): 8.99 (d, J₄=2.0 Hz, 2H), 8.40 (dd, J₃=9.2 Hz, J₄=2.0 Hz, 2H), 8.22 (d J₃=7.8 Hz, 2H), 7.56 (t, J₃=8.2 Hz, 2H), 7.52 (d, J₃=8.2 Hz, 2H), 7.47 (d, J₃=9.2 Hz, 2H), 7.43 (d, J₃ 8.3 Hz, 4H), 7.35 (t, J₃=7.8 Hz, 2H), 2.36 (s, 6H).

### Examples A3

### Blend Constituents of the Formula (II)

The blend constituents of the formula (II) are designated below as CARB.

### CARB1: N-(N-Carbazolyl)propylcarbazole (n=3):

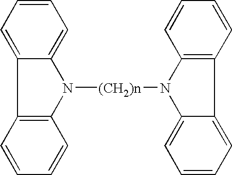

Under protective gas, 0.99 g (41.2 mmol) of sodium hydride was added to a suspension of 5.15 g (30.8 mmol) of carbazole in 160 ml of dry THF. After the evolution of hydrogen had ended, 3.11 g (15.4 mmol) of 1,3-dibromopropane were added through a septum and the mixture was stirred at RT overnight with exclusion of moisture. The sodium bromide which formed was filtered off, THF was removed under reduced pressure and excess dibromopropane was recovered in an oil-pump vacuum. The product was purified by column chromatography (silica gel/CHCl₃).

Yield: 5.4 g (94%), HPLC purity 99.9%.

¹H NMR (CDCl₃, 500 MHz): 8.11 (m, 4H), 7.44-7.38 (m, 4H), 7.28-7-17 (m, 8H), 4.49 (t, J=7.02 Hz, 4H), 2.22 (m, 2H).

### Examples A4

### Structural Units COMP1 for Use in Blends

The compounds COMP1 used here by way of example are derivatives of tris(phenylpyridyl)iridium(III). The synthesis of these compounds is already described in the application documents WO 02/081488 and WO 04/026886. For clarity, the iridium complexes used here are shown once again below:

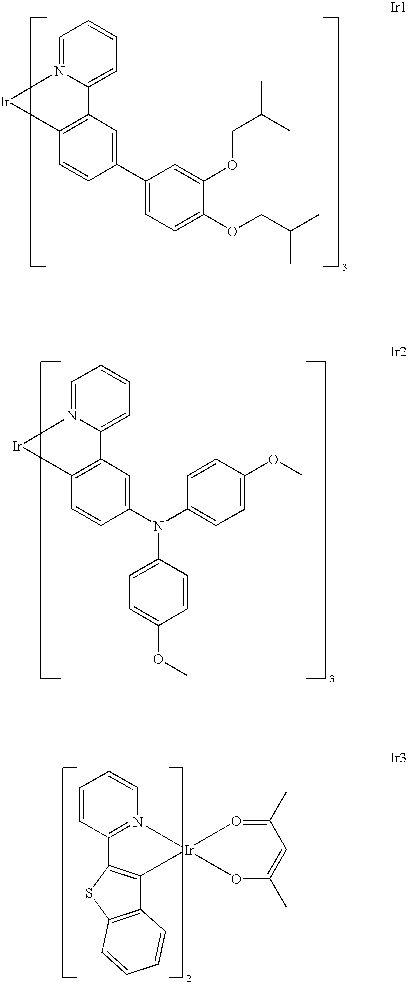

### Examples A5

### Triplet Comonomers COMP2

The comonomers COMP2 used here are derivatives of tris(phenylpyridyl)iridium(III). The synthesis of these compounds is described, for example, in the application DE 10350606.3 which had not been published at the priority date of the present application. The iridium comonomers Ir4 and Ir5 used here are depicted once more below for clarity: 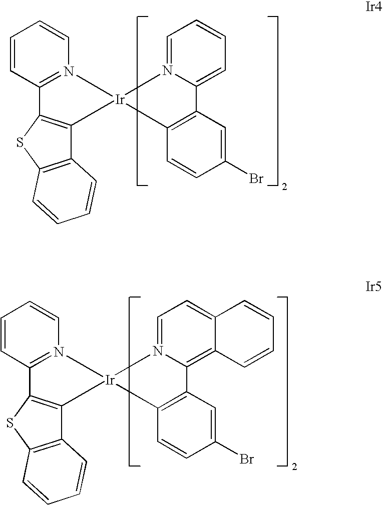
Part B: Preparation of the Polymers

The synthesis of conjugated polymers POLY3 which do not contain any units of the formula (I) or any compounds COMP2 has already been described in the application documents WO 02/077060 and WO 03/020790. These are part of the present application by reference.

The synthesis of two polymers of the POLY1 type which contain monomers of the formula (I) is described by way of example below.

### Example B1

### Synthesis of Polymer P1

3.1706 g (4 mmol) of monomer M2, 1.9650 g (2.4 mmol) of monomer M1, 0.6069 g (0.8 mmol) of monomer M9, 0.4258 g (0.8 mmol) of IM1 and 4.05 g of potassium phosphate hydrate were dissolved in 25 ml of dioxane, 25 ml of toluene and 7 ml of H₂O (all solvents oxygen-free). The reaction solution was degassed with argon at 40° C. for 30 minutes. Then, 0.45 mg of Pd(OAc)₂ and 3.65 mg of P(o-tolyl)₃ were added as a catalyst, and the solution was heated under an argon atmosphere under reflux for 4 h. The end-capping was carried out with 24 mg of 3,4-bispentoxybenzeneboronic acid in 20 ml of toluene and the mixture was heated under reflux for 1 h. Then, 40 mg of 3,4-bispentoxybenzyl bromide in 10 ml of toluene were added and the mixture was heated under reflux for 3 h. After addition of a further 50 ml of toluene, the polymer solution was stirred at 60° C. with 100 ml of 0.01% aqueous NaCN solution for 3 h. The phases were separated and the organic phase was washed with 4×100 ml of H₂O. The polymer was precipitated by dropwise addition into 300 ml of methanol and filtered. Further purification was effected by dissolution in 300 ml of THF at 60° C. under argon, filtration through Celite and reprecipitation by addition of 600 ml of methanol. The polymer was filtered and dried under reduced pressure. 4.73 g (93% of theory) of polymer were isolated; M_{w}=352 000 g/mol, Mₙ=93 000 g/mol, polydispersity=3.8 (GPC in THF with a PS standard).

### Example B2

### Synthesis of Polymer P2

3.1760 g (4 mmol) of 6monomer M2, 1.0825 g (1.6 mmol) of monomer M7, 1.7726 g (2.4 mmol) of IM3 and 4.05 g of potassium phosphate hydrate were dissolved in 37.5 ml of dioxane, 12.5 ml of toluene and 7 ml of H₂O (all solvents oxygen-free). The reaction solution was degassed with argon at 40° C. for 30 min. Then, 0.45 mg of Pd(OAc)₂ and 3.65 mg of P(o-tolyl)₃ were added as a catalyst and the solution was heated under an argon atmosphere under reflux for 3 h. The highly viscous polymer solution was diluted with 50 ml of toluene. The end-capping was then carried out by adding 24 mg of 3,4-bispentoxybenzeneboronic acid in 20 ml of toluene, the mixture was heated under reflux for 1 h, then 40 mg of 3,4-bispentoxybenzyl bromide in 30 ml of toluene were added and the mixture was heated under reflux for 1 h. The polymer solution was once again diluted with 50 ml of toluene and stirred at 60° C. with 100 ml of 0.01% aqueous NaCN solution for 3 h. The phases were separated and the organic phase was washed with 4×100 ml of H₂O. The polymer was precipitated by dropwise addition to 400 ml of methanol and filtered. Further purification was effected by dissolution in 350 ml of THF at 60° C. under argon, filtration through Celite and reprecipitation by addition of 700 ml of methanol. The polymer was filtered and dried under reduced pressure. 4.69 g (90% of theory) of polymer were isolated; M_{w}=681 000 g/mol, Mₙ=202 000 g/mol, polydispersity =3.4 (GPC in THF with a PS standard).

Further polymers were prepared analogously to the descriptions for P1 and P2.

Part C: Preparation of the Blends

The blends were prepared by dissolving the blend constituents in the desired ratio and in the desired concentration in a suitable solvent. The solvent used here was toluene. The dissolution operation was carried out at 60° C. in an inert atmosphere. The solution was processed directly without isolation of the blend (repeated precipitation of the solid fractions).

Part D: Production and Characterization of LEDs

All thus obtained blends BLEND1 to BLEND4 and polymers POLY4 were also investigated for use in PLEDs. The results obtained with the blends (color, efficiency, operating voltage) are compiled in Table 1 (Examples D1 to D6), as are results which were obtained with comparative polymers and blends and did not contain any units of the formula (I) or formula (II) (Examples V1 to V4). The results obtained with the polymers POLY4 are compiled in Table 2 (Examples D7 and D8). The production of the PLEDs is described in detail in DE 10249723.0 and the literature cited therein.

TABLE 1

| | Composition | | | | | | | | | | |
|---|---|---|---|---|---|---|---|---|---|---|---|
| | POLY1 | | | | | | | Electroluminescence | | | |
| | composition | | | | | | | | Max. eff. | U @ 100 | |
| Example | M1^{a} | M2^{d} | M9^{a} | EM^{a} | CARB1^{b} | COMP1^{b} | Others^{b} | λₘₐₓ [nm] | [cd/A] | cd/m² [V] | CIE x/y^{d} |
| Example D1 | 30 | 50 | 10 | 10 IM1 | | Ir2 (8%) | | 605 nm | 9.28 cd/A | 7.71 V | 0.60/0.40 |
| Example D2 | 30 | 50 | 10 | 10 IM1 | | Ir3 (8%) | | 620 nm | 4.35 cd/A | 4.42 V | 0.69/0.31 |
| Example D3 | 30 | 50 | 10 | 10 IM1 | 20 | Ir2 (8%) | | 607 nm | 9.37 cd/A | 7.82 V | 0.61/0.39 |
| Example D4 | 30 | 50 | 10 | 10 IM1 | 20 | Ir3 (8%) | | 620 nm | 4.96 cd/A | 4.16 V | 0.69/0.31 |
| Example D5 | 30 | 50 | 10 | 10 IM1 | 40 | Ir2 (8%) | | 609 nm | 9.31 cd/A | 7.25 V | 0.61/0.39 |
| Example D6 | 30 | 50 | 10 | 10 IM1 | 40 | Ir3 (8%) | | 620 nm | 5.38 cd/A | 3.83 V | 0.69/0.31 |
| Example V1 | | | | | | Ir2 (2%) | 18% CPB^{c}, | 600 nm | 0.18 cd/A | 6.70 V | 0.57/0.43 |
| (Comparative) | | | | | | | 80% PVK^{c} | | | | |
| Example V2 | 40 | 50 | 10 | | | Ir2 (5%) | | 605 nm | 0.40 cd/A | 6.52 V | 0.60/0.40 |
| (Comparative) | | | | | | | | | | | |
| Example V3 | | | | | | Ir3 (2%) | 18% CPB^{c}, | 620 nm | 1.06 cd/A | 9.91 V | 0.67/0.33 |
| (Comparative) | | | | | | | 80% PVK^{c} | | | | |
| Example V4 | 40 | 50 | 10 | | | Ir2 (8%) | | 609 nm | 0.32 cd/A | 8.78 V | 0.60/0.40 |
| (Comparative) | | | | | | | | | | | |

^{a}Contents of the different monomers in the polymer in mol %.
^{b}Type and contents of the blend constituents CARB and COMP1 and other blend constituents in the total composition of the mixture in % by weight.
^{c}CPB = 2,2′,7,7′-tetra(N-carbazolyl)-9,9′-spirobifluorene, PVK = poly(vinylcarbazole).
^{d}CIE coordinates: Chromaticity coordinates of the Commission Internationale de I'Eclairage.

TABLE 2

| | | | | | | Electroluminescence | | |
|---|---|---|---|---|---|---|---|---|
| | POLY4 composition | | | | | Max. eff. | U @ | |
| Example | M2^{a} | M7^{a} | M9^{a} | IM^{a} | Ir^{a} | [cd/A] | 100 cd/m² | CIE x/y^{b} |
| D7 | 50 | 25 | 10 | IM1 | Ir4 | 7.6 cd/A | 4.1 V | 0.61/0.39 |
| | | | | (10 mol %) | (5 mol %) | | | |
| D8 | 50 | 29 | 10 | IM1 | Ir5 | 3.6 cd/A | 5.1 V | 0.68/0.32 |
| | | | | (10 mol %) | (1 mol %) | | | |

^{a}Contents of the different monomers in the polymer in mol %.
^{b}CIE coordinates: chromaticity coordinates of the Commission Internationale de I'Eclairage.

1. Mixtures (blends) comprising
(A) at least one conjugated polymer,
(B) at least one bridged carbazole unit and
(C) at least one triplet emitter.

2. The mixture as claimed in claim 1, characterized in that it contains at least 0.5% by weight of at least one conjugated polymer, at least 1% by weight of at least one bridged carbazole unit and at least 0.1% by weight of at least one triplet emitter.

3. The mixture as claimed in claim 1, characterized in that the mixture comprises, as the bridged carbazole unit, at least one compound of the formula (I) 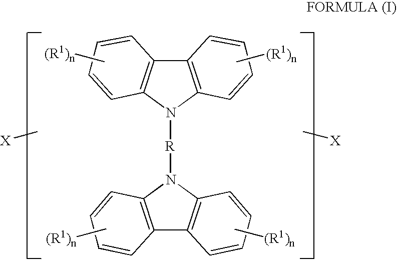
where the symbols and indices are defined as follows:
R is the same or different at each instance and is a straight-chain, branched or cyclic alkylene chain which has from 1 to 40 carbon atoms and is optionally R¹-substituted or unsubstituted, in which one or more nonadjacent carbon atoms is optionally replaced by —NR²—, —O—, —S—, —CO—, —CO—O—, —CO—NR²—, —O—CO—O, or is a bivalent, aromatic or heteroaromatic ring system which has from 2 to 40 carbon atoms and is optionally R¹-substituted or unsubstituted, an R¹-substituted or unsubstituted vinylene unit, an acetylene unit or a combination of from 2 to 5 of these systems; the aromatic units is optionally part of a larger fused system; the possible substituents R¹ may optionally be situated at any free position;
R¹ is the same or different at each instance and is a straight-chain, branched or cyclic alkyl or alkoxy chain having from 1 to 22 carbon atoms, in which one or more nonadjacent carbon atoms is optionally replaced by —NR²—, —O—, —S—, —CO—O—, —O—CO—O—, in which one or more hydrogen atoms is optionally replaced by fluorine, or is an aryl or aryloxy group having from 5 to 40 carbon atoms, in which one or more carbon atoms is optionally replaced by O, S or N, and which is optionally substituted by one or more nonaromatic R¹ radicals, a vinyl or acetylene group or F, Cl, Br, I, NO₂, CN, N(R²)₂, B(R²)₂, Si(R²)₃, and two or more R¹ radicals together may also form an aliphatic or aromatic, mono- or polycyclic ring system;
R² is the same or different at each instance and is H, a straight-chain, branched or cyclic alkyl chain having from 1 to 22 carbon atoms, in which one or more nonadjacent carbon atoms is optionally replaced by O, S, —CO—O—, —O—CO—O—, and in which one or more hydrogen atoms is optionally replaced by fluorine, or is an aryl group having from 5 to 40 carbon atoms, in which one or more carbon atoms is optionally replaced by O, S or N and which is optionally substituted by one or more nonaromatic R² radicals;
two or more R² radicals together optionally form a ring system;
n is the same or different at each instance and is 0, 1, 2, 3 or 4, with the proviso that n must not be 4 when there is a linkage to the polymer chain (i.e. X) on this phenyl unit, and that n must not be 3 or 4 when both linkages to the polymer chain (i.e. X) are on this phenyl unit;
X describes the linkage of the unit to the conjugated polymer,
and/or of the formula (II) 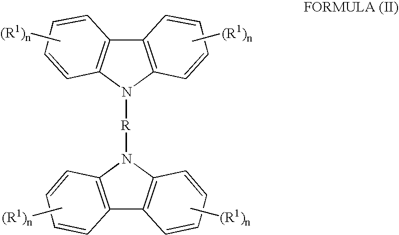
where the symbols R, R¹, R² and the indices n are each as defined under formula (I).

4. Mixtures BLEND1 as claimed in claim 3, containing
(A) 5-99.5% by weight of at least one conjugated polymer POLY1 which contains 1-100 mol % of one or more units of the formula (I) 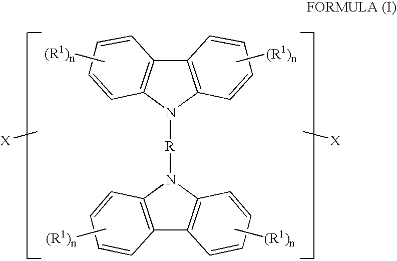
where the symbols and indices are each defined as described under claim 3;
and
(B) 0.1-95% by weight of one or more triplet emitters (COMP1).

5. Mixtures BLEND2 as claimed in claim 3, containing
(A) 0.5-99% by weight of at least one conjugated polymer POLY2 which contains, in covalently bonded form, 0.1-100 mol % of one or more triplet emitters (COMP2)
and
(B) 1-99.5% by weight of a structural unit of the formula (II) 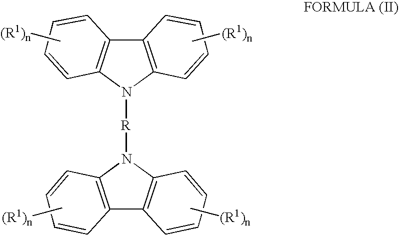
where the symbols and indices are each as defined in claim 3.

6. Mixtures BLEND3 as claimed in claim 3, containing
(A) 0.5-98.5% by weight of any conjugated polymer POLY3;
and
(B) 1-99% by weight of a structural unit of the formula (II) 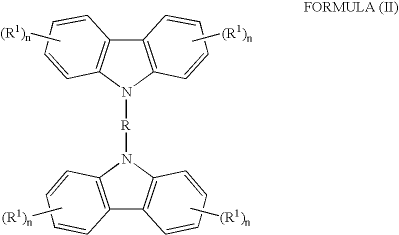
where the symbols and indices are each as defined in claim 3,
and
(C) 0.1-95% by weight of one or more triplet emitters (COMP1).

7. Mixtures BLEND4 as claimed in claim 3, containing
(A) 0.5-98.5% by weight of any conjugated polymer POLY3 or a plurality thereof;
and
(B) 1.5-99.5% by weight of a compound COMP3 which contains one or more triplet emitters bonded covalently to at least one structural unit of the formula (II) 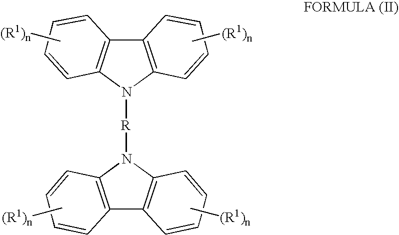
where the symbols and indices are each as defined in claim 3 and the bond between the triplet emitter and the structural unit of the formula (II) may be at any positions in the triplet emitter and in the structural unit of the formula (II).

8. Mixtures as claimed in, characterized in that the structural units of the formula (I) are incorporated into POLY1 via the 3,6-position or the 2,7-position of a carbazole.

9. Mixtures as claimed in claim 4, characterized in that the structural units of the formula (I) are incorporated into POLY1 via the 3,3′-position or the 2,2′-position of the two carbazole units when R describes an aryl, heteroaryl, vinyl or acetylene unit or a combination of these systems.

10. Mixtures as claimed in claim 4, characterized in that the structural units of the formula (I) are incorporated into POLY1 via the bridge R or via one or two substituents R¹ when R and R¹ describe an aryl, heteroaryl, stilbenyl or tolanyl unit or a combination of these systems.

11. Mixtures as claimed in claim 4, characterized in that the further structural elements of the polymer POLY1 is selected from the groups of ortho-, meta- or para-phenylenes, 1,4-naphthylenes, 9,10-anthracenylenes, 2,7-phenanthrenylenes, 1,6- or 2,7- or 4,9-pyrenes or 2,7-tetrahydropyrenes, oxadiazolylenes, 2,5-thiophenylenes, 2,5-pyrrolylenes, 2,5-furanylenes, 2,5-pyridylenes, 2,5-pyrimidinylenes, 5,8-quinolinylenes, fluorenes, spiro-9,9′-bifluorenes, indenofluorenes or heteroindenofluorenes.

12. Mixtures as claimed in claim 11, characterized in that further structural elements which improve the charge transport and/or the charge injection and/or the charge equilibrium are present in the polymer POLY1.

13. Mixtures as claimed in claim 12, characterized in that the further structural elements are selected from the groups of the triarylamines or the oxadiazolylenes.

14. Mixtures as claimed in claim 3, characterized in that the symbols and indices of the formula (I) are:
R is the same or different at each instance and is a straight-chain or branched alkyl chain which has from 3 to 10 carbon atoms and may be unsubstituted or R¹-substituted, in which one or more nonadjacent carbon atoms is optionally replaced by —N—R²—, —O— or —S—, a bivalent aromatic or heteroaromatic ring system selected from thiophene, benzene, biphenyl, naphthalene, anthracene or phenanthrene, each of which is unsubstituted or substituted by one or two substituents R¹, a 9,9′-substituted fluorene, a spirobifluorene substituted by from 0 to 4 substituents R¹, a 9,10- or 9,9,10,10-substituted dihydrophenanthrene, a stilbenyl or tolanyl system which bears from 0 to 2 substituents R¹ at the free positions, or combinations of 2 or 3 of these systems;
R¹, R² are each as described in claim 3;
n is the same or different at each instance and is 0, 1 or 2;
the linkage to the polymer chain is via the 3,6- or the 2,7-position or via the 3,3′-position
when R is an aryl, heteroaryl, stilbenyl or tolanyl system, or via two positions on R itself or on R¹ when R or R¹ is an aryl, heteroaryl, stilbenyl or tolanyl system, so that the number of aromatic atoms between the points of linkage is a multiple of four, and that the symbols and indices of the formula (II) are:
R is the same or different at each instance and is a straight-chain or branched alkyl chain which has from 3 to 10 carbon atoms and may be unsubstituted or R¹-substituted, in which one or more nonadjacent carbon atoms is optionally replaced by —N—R²—, —O— or —S—, a bivalent aromatic or heteroaromatic ring system selected from thiophene, benzene, biphenyl, naphthalene, anthracene or phenanthrene, each of which is unsubstituted or substituted by one or two substituents R¹, a 9,9′-substituted fluorene, a spirobifluorene substituted by from 0 to 4 substituents R¹, a 9,10- or 9,9,10,10-substituted dihydrophenanthrene, a stilbenyl or tolanyl system which bears from 0 to 2 substituents R¹ at the free positions, or combinations of 2 or 3 of these systems;
R¹, R² are each as described in claim 3;
n is the same or different at each instance and is 0, 1 or 2.

15. (canceled)

16. (canceled)

17. Mixtures as claimed in claim 1, characterized in that the triplet emitter contains heavy atoms.

18. Mixtures as claimed in claim 17, characterized in that the triplet emitter comprises d and/or f transition metals.

19. Mixtures as claimed in claim 18, characterized in that the triplet emitter comprises metals of groups 8 to 10 of the periodic table of elements.

20. Mixtures as claimed in claim 5, characterized in that the triplet emitter (COMP2) is incorporated into the main chain of the polymer (POLY2).

21. Mixtures as claimed in claim 5, characterized in that the triplet emitter (COMP2) is incorporated into the side chain of the polymer (POLY2).

22. Mixtures as claimed in claim 4, characterized in that any further molecules, which may be low molecular weight, oligomeric, dendritic or polymeric, may also be added to the mixtures as claimed in claim 4 (BLEND1).

23. Mixtures as claimed in claim 4, characterized in that structural units of the formula (II) are additionally added to the mixture as claimed in claim 4 (BLEND1).

24. Mixtures as claimed in claim 23, characterized in that the total content of structural units of the formula (I) and formula (II) is 20-99 mol %.

25. Conjugated polymers (POLY4) containing
(A) 1-99.9 mol % of units of the formula (I) 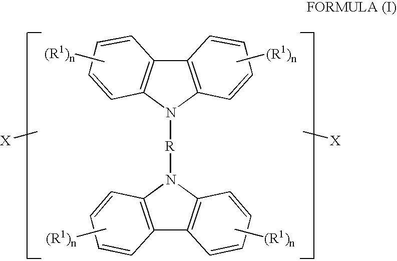
where the symbols and indices are each as defined in claim 3, and
(B) 0.1-95 mol % of one or more triplet emitters.

26. Mixtures of at least one polymer as claimed in claim 25, characterized in that further molecules, which may be low molecular weight, oligomeric, dendritic or polymeric, may be added to the polymer (POLY4).

27. Compounds of the formula (LIX) 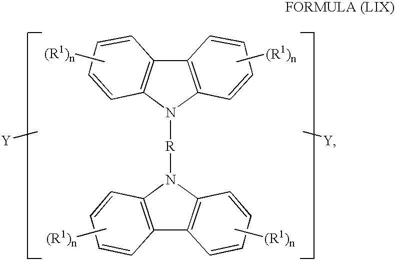
characterized in that the two functional groups Y are the same or different and copolymerize under conditions for C—C or C—N bond formations, and the further symbols and indices are each as defined in claim 3.

28. Compounds as claimed in claim 27, characterized in that Y is selected from the groups of Cl, Br, I, O-tosylate, O-triflate, OSO₂R², B(OH)₂, B(OR²)₂, Sn(R²)₃ and NHR² where
R² is the same or different at each instance and is H, a straight-chain, branched or cyclic alkyl chain having from 1 to 22 carbon atoms, in which one or more nonadjacent carbon atoms is optionally replaced by O, S, —CO—O—, —O—CO—O—, and in which one or more hydrogen atoms is optionally replaced by fluorine, or is an aryl group having from 5 to 40 carbon atoms, in which one or more carbon atoms is optionally replaced by O, S or N and which is optionally substituted by one or more nonaromatic R² radicals.

29. Compounds as claimed in claim 27 characterized in that the C—C or C—N bond formations are selected from the groups of the SUZUKI coupling, the YAMAMOTO coupling, the STILLE coupling and the HARTWIG-BUCHWALD coupling.

30. Compounds as claimed in claim 27, characterized in that the monomeric compounds of the formula (LIX) lead in the polymer to structural units of the formula (III) to (XXXVIII).

31. (canceled)

32. An electronic component which comprises one or more active layers, at least one of these layers comprising one or more mixtures or polymers as claimed in claim 1.

33. The electronic component as claimed in claim 32, characterized in that it is an organic light-emitting diode, organic solar cell, organic laser diode, an organic optical detector or a device for nonlinear optics.

34. Mixtures as claimed in claim 3, characterized in that the structural elements of the formula (I) are selected from the formulae (III) to (XXXVIII) which may be substituted or unsubstituted

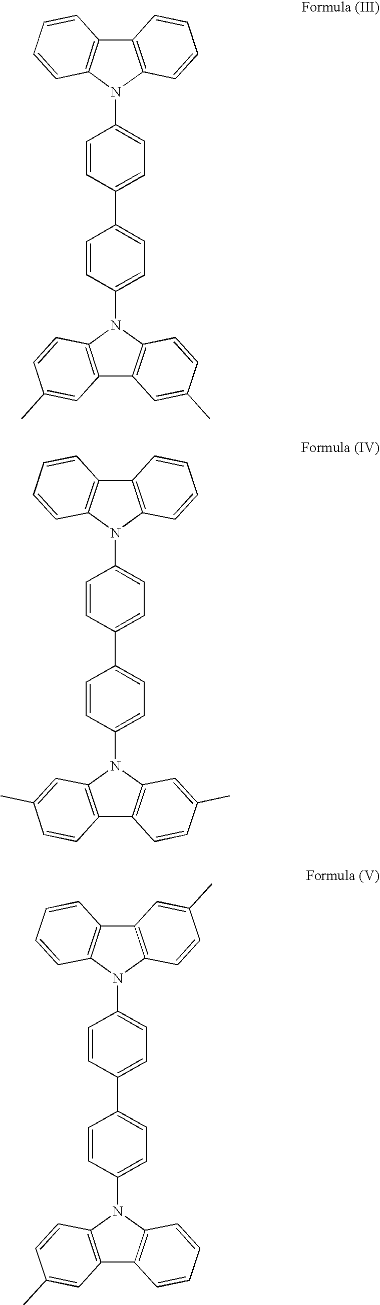

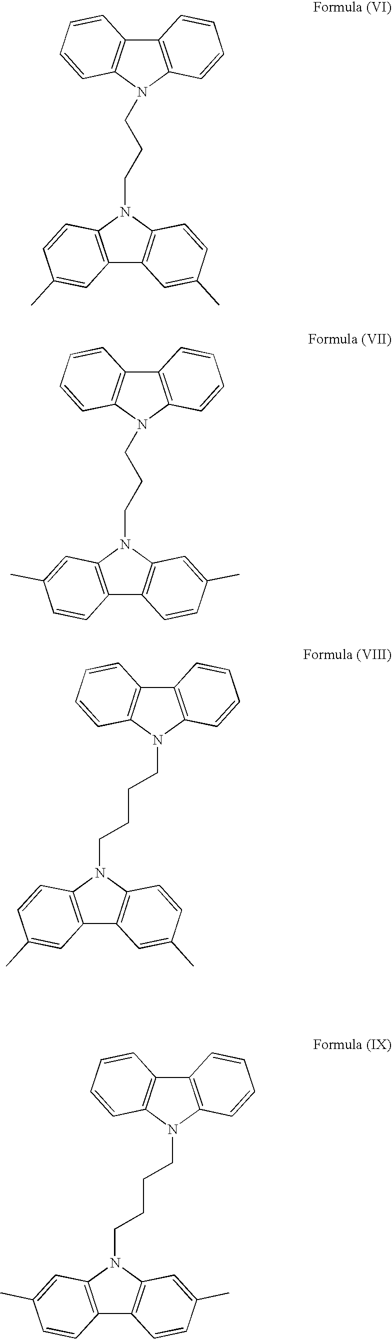

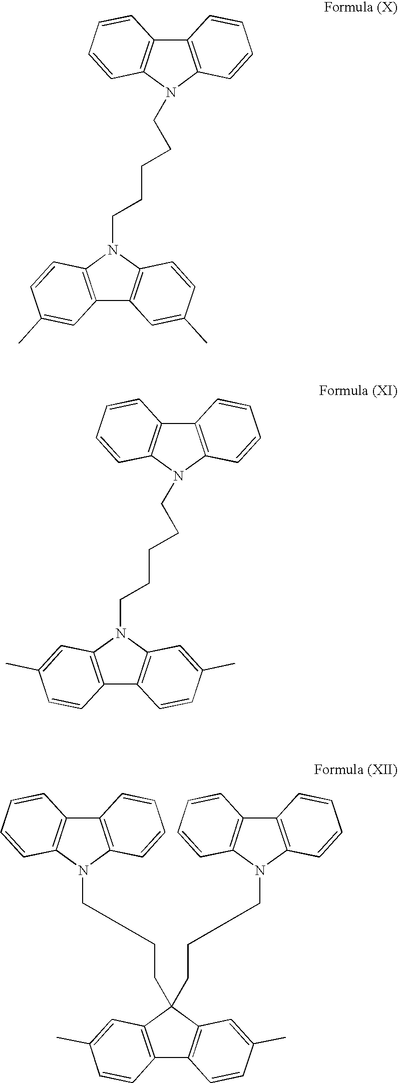

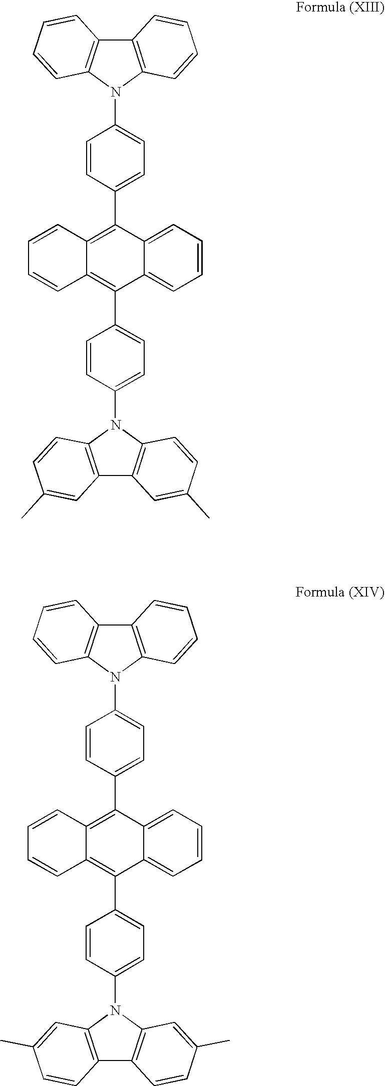

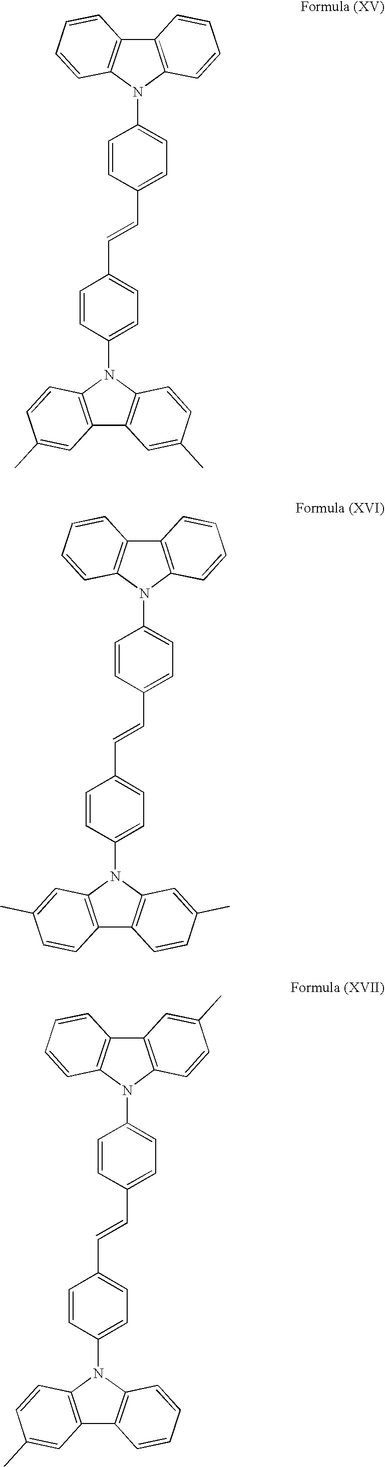

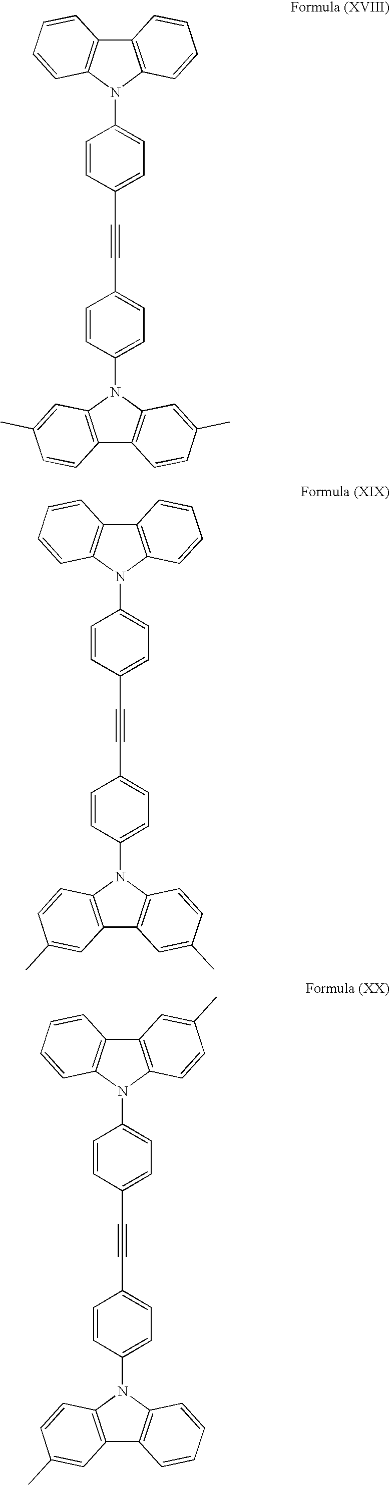

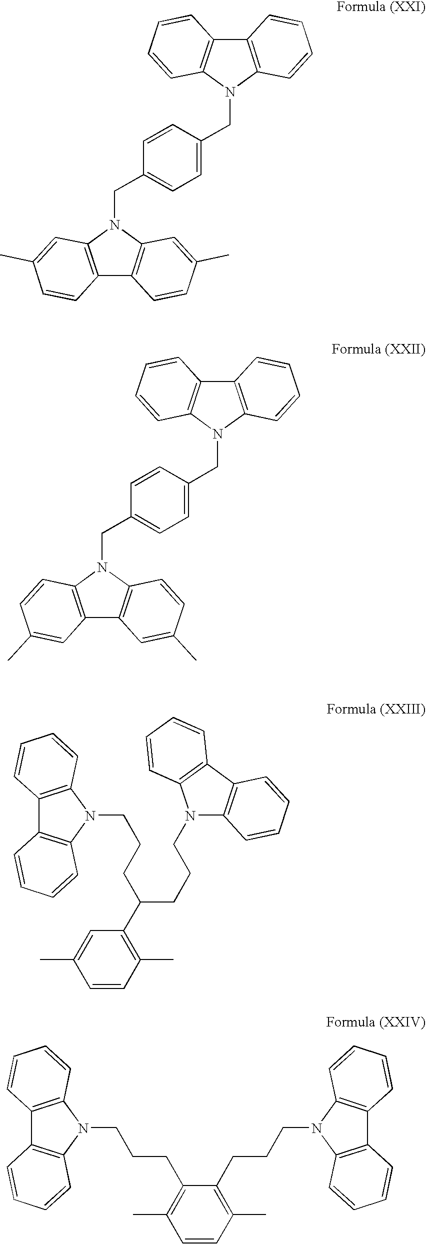

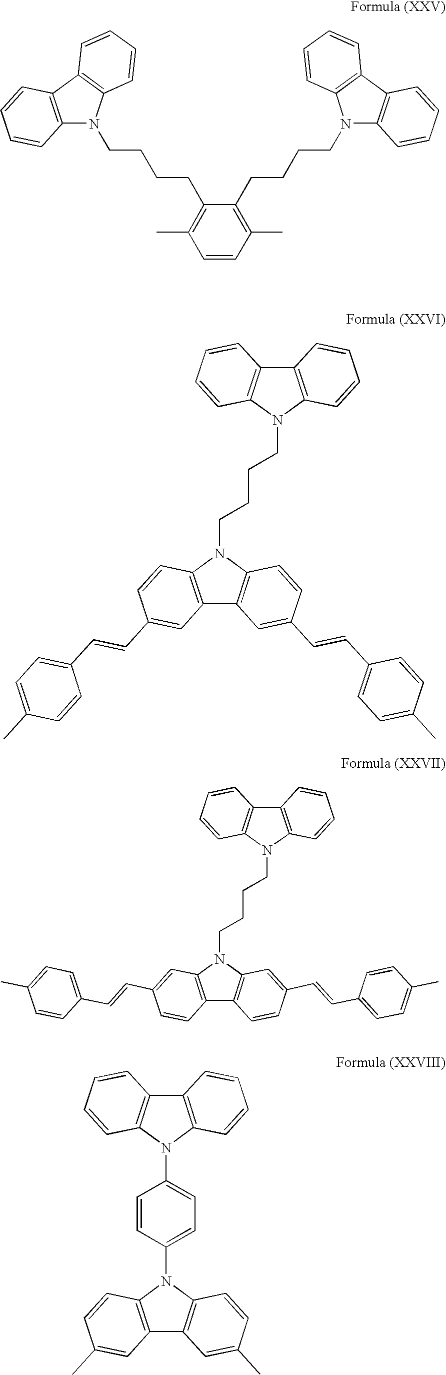

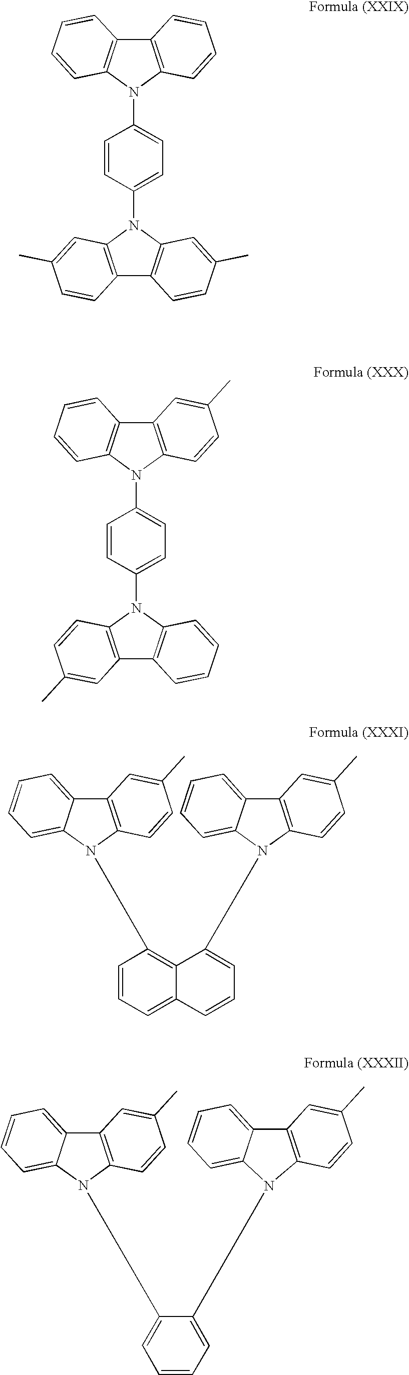

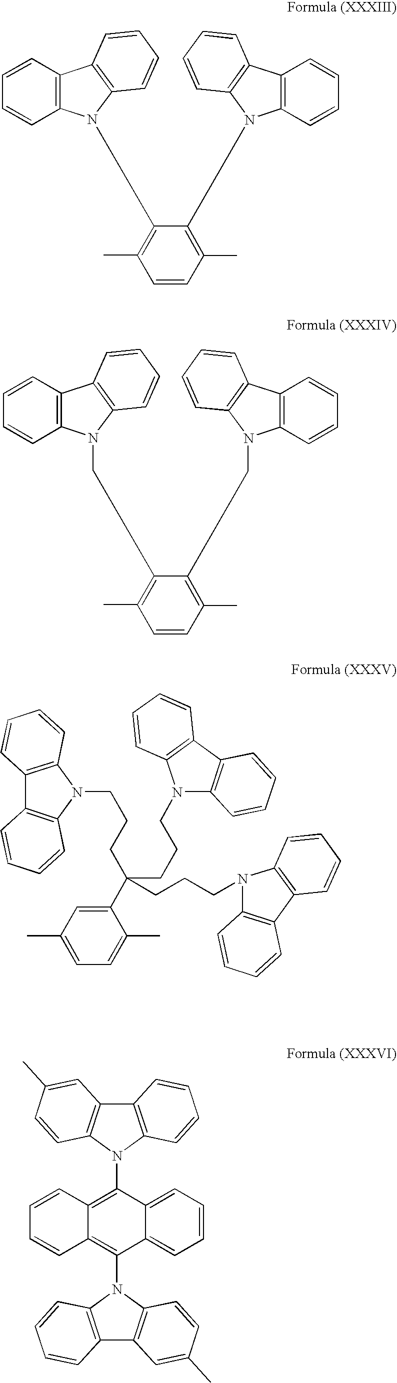

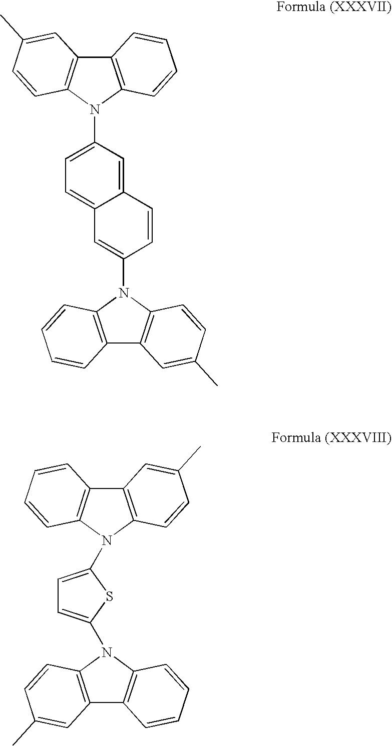

35. Mixtures as claimed in claim 3, characterized in that the structural elements of the formula (II) are selected from the formulae (XXXIX) to (LVIII) which may be substituted or unsubstituted

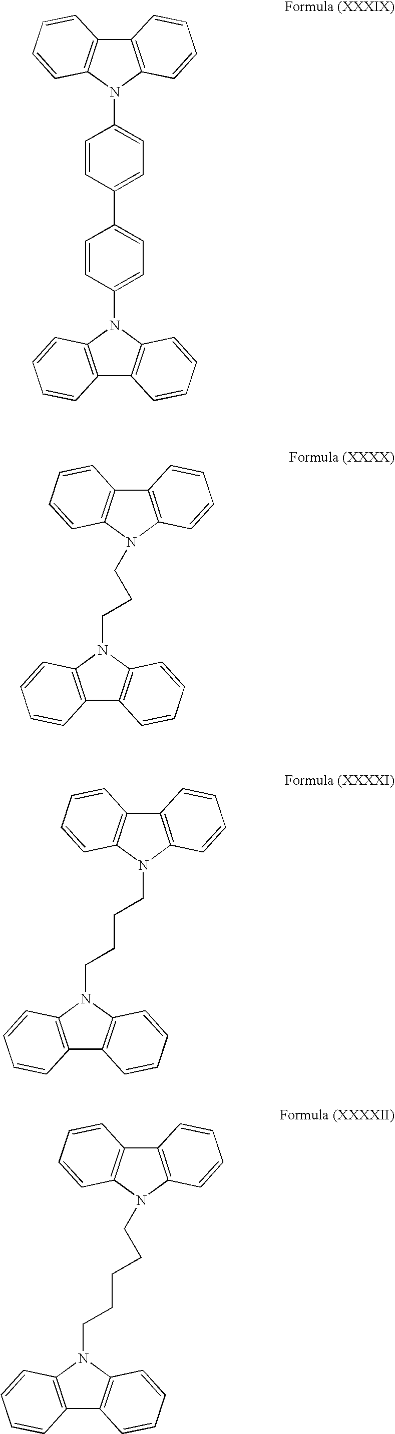

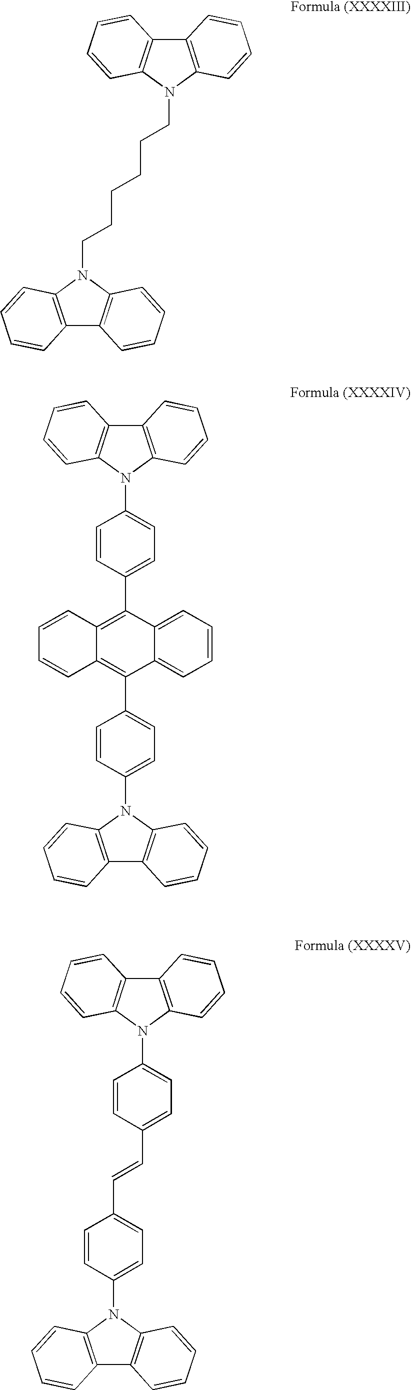

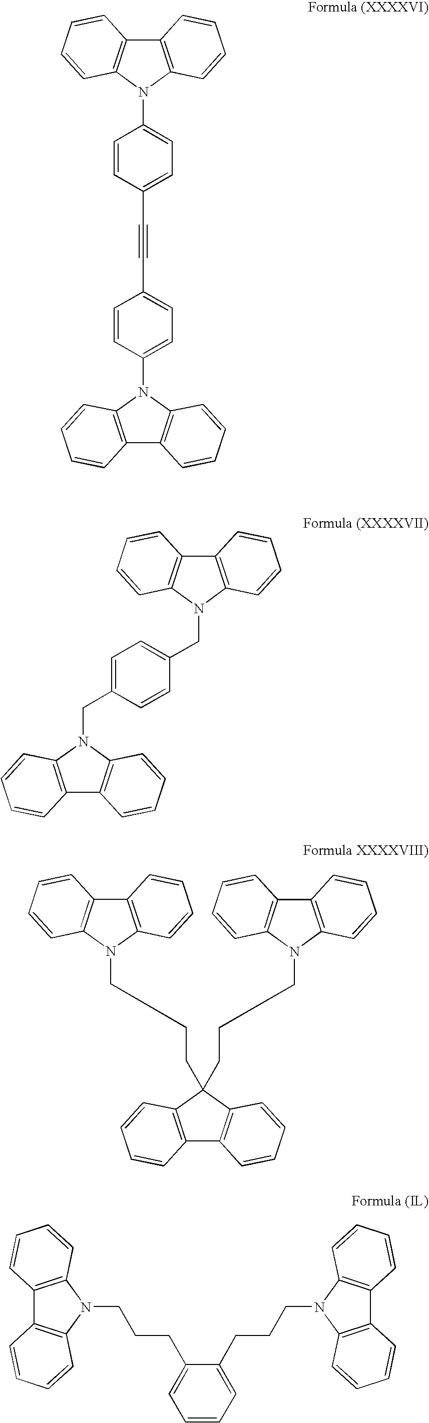

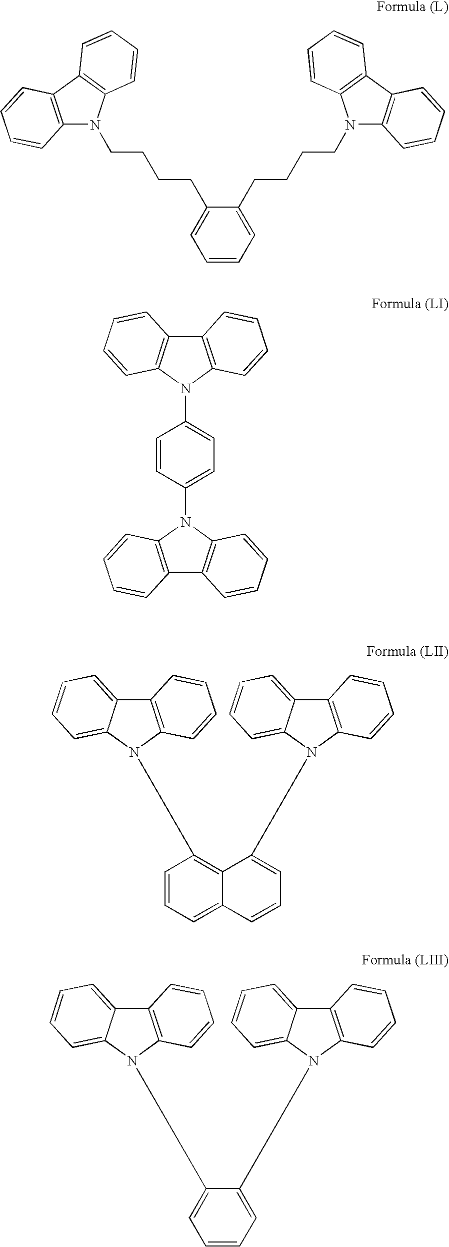

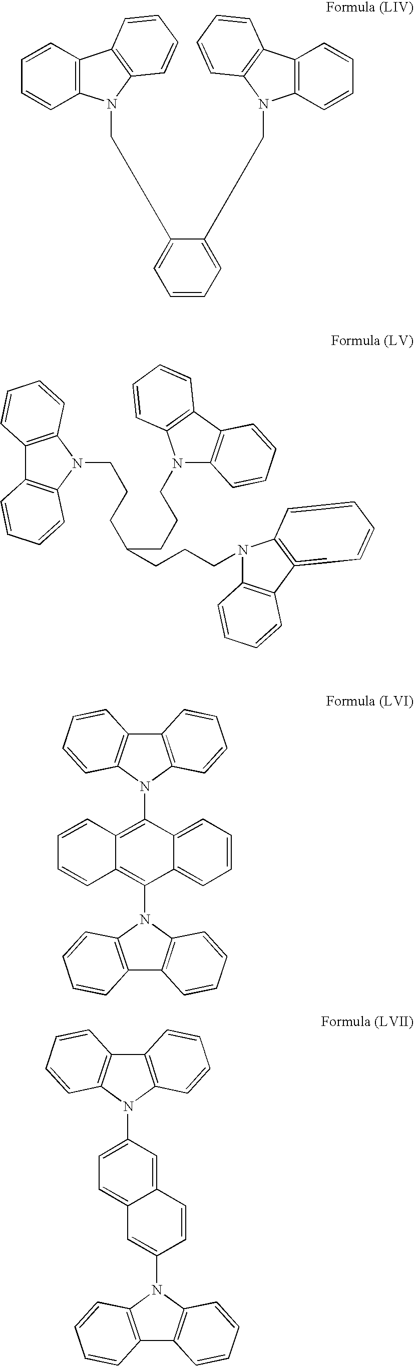

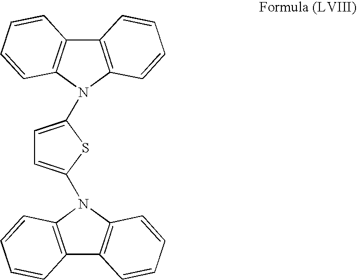

36. Compounds as claimed in claim 27, characterized in that the monomeric compounds of the formula (LIX) lead in the polymer to structural units of the formula (III) to (XXXVIII)

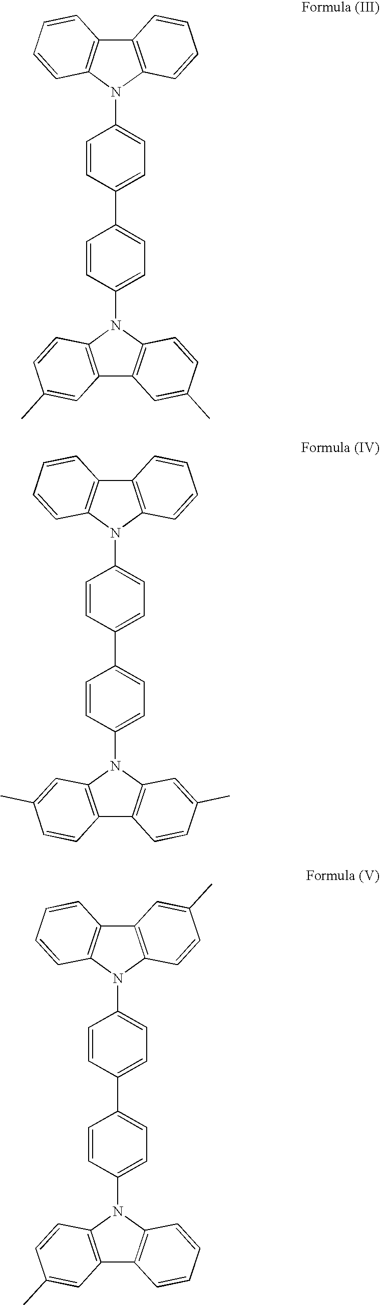

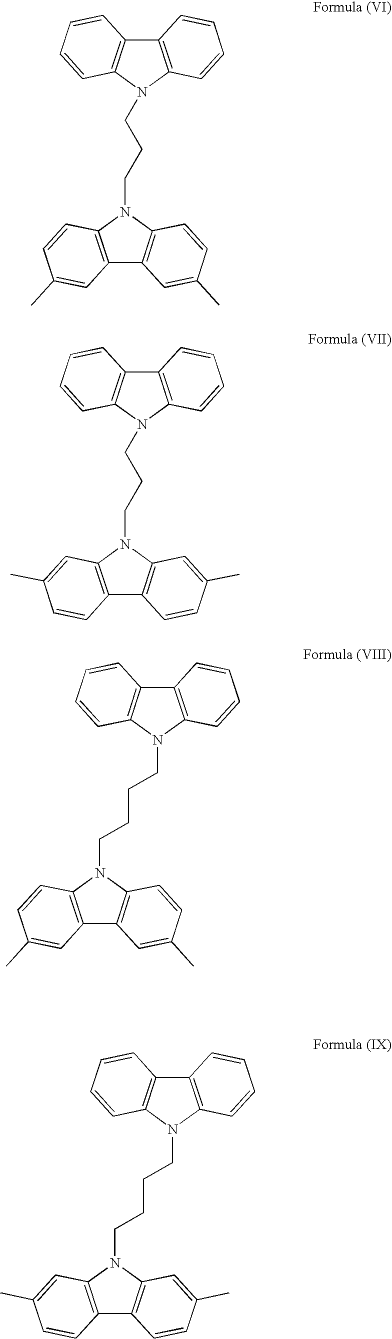

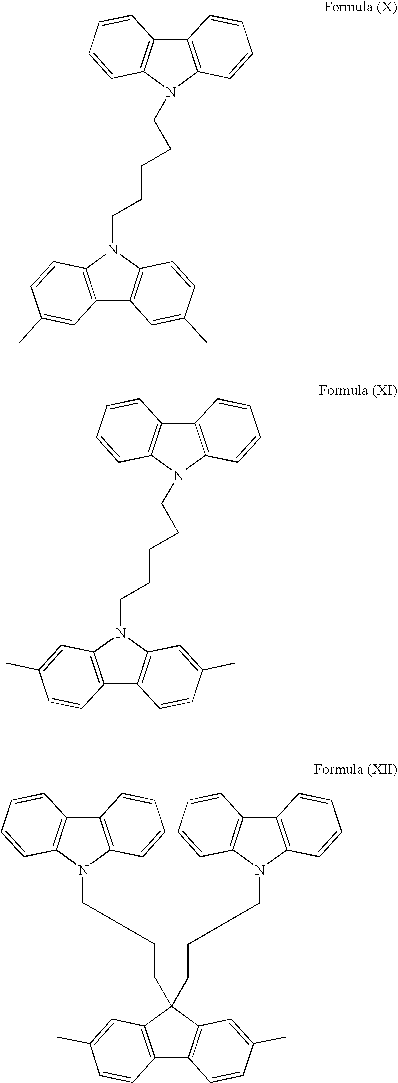

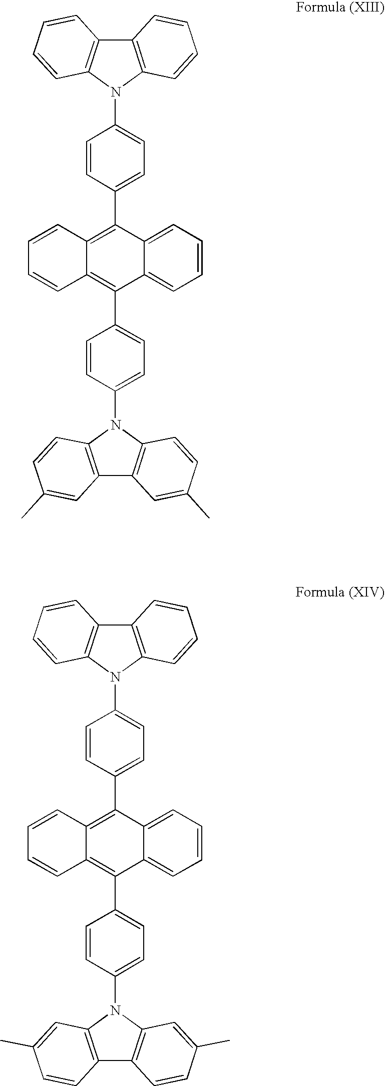

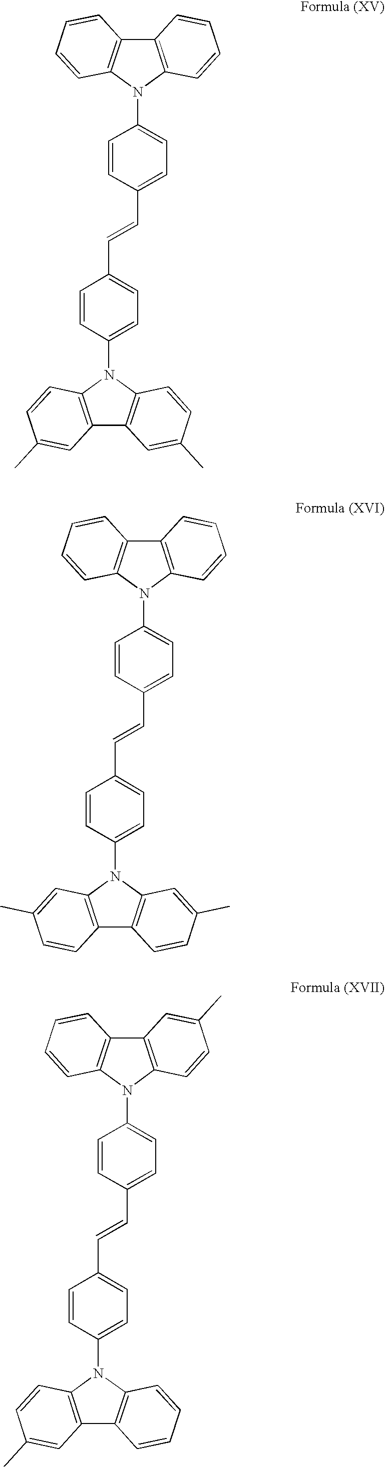

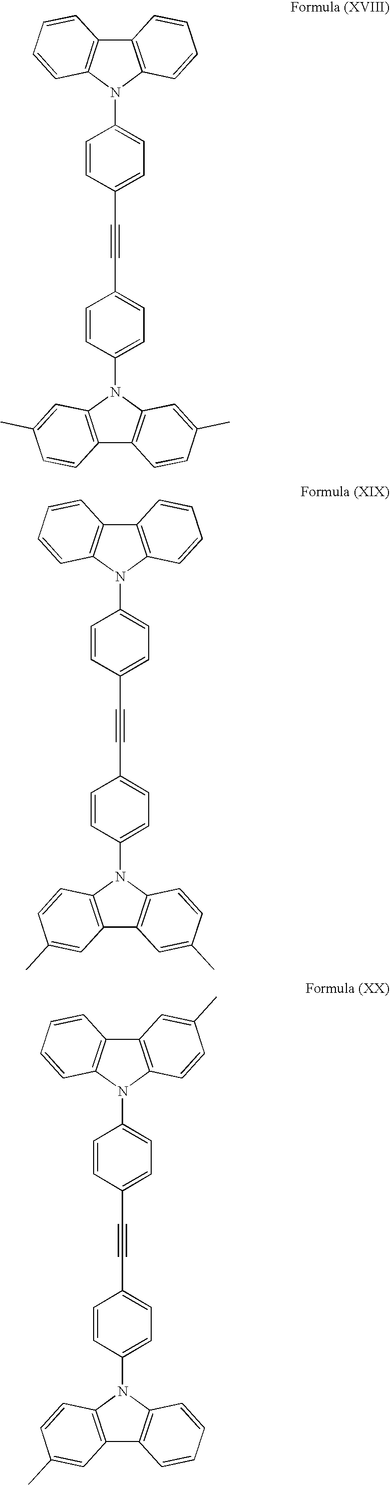

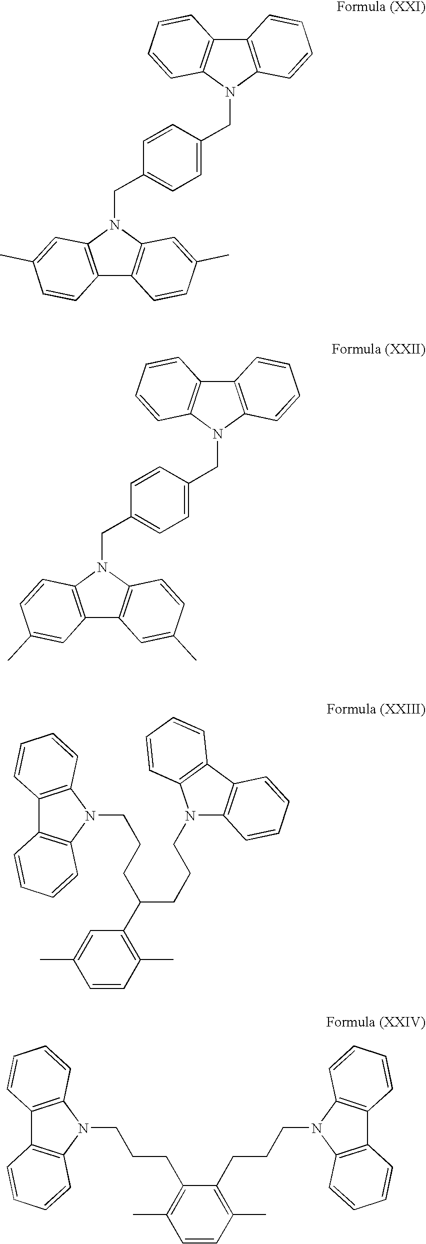

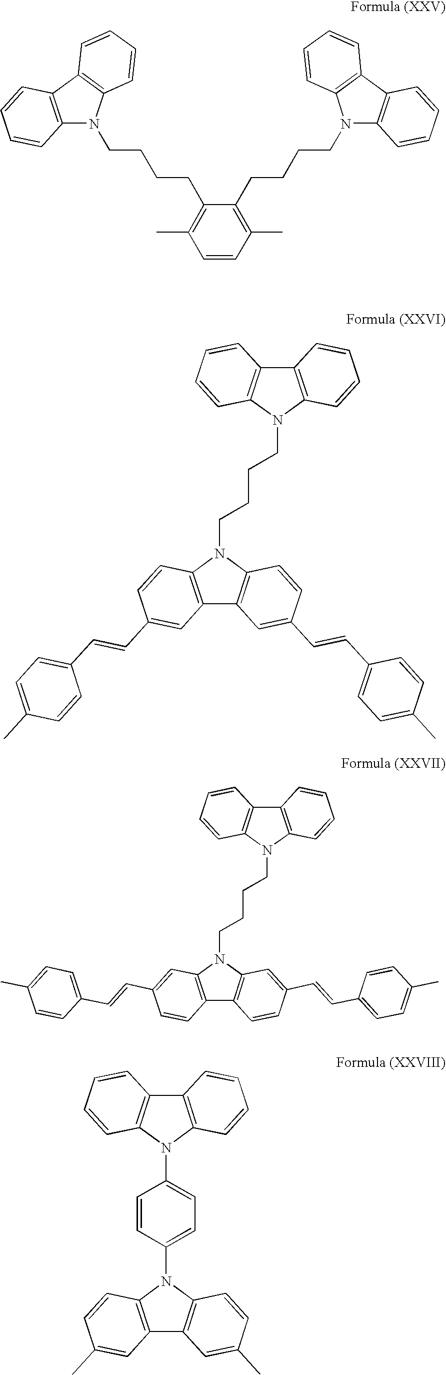

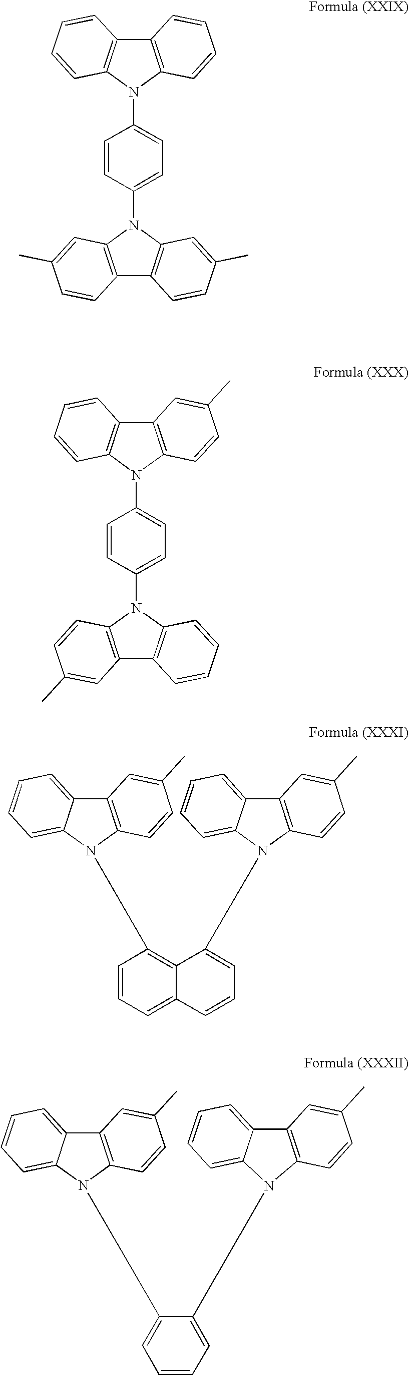

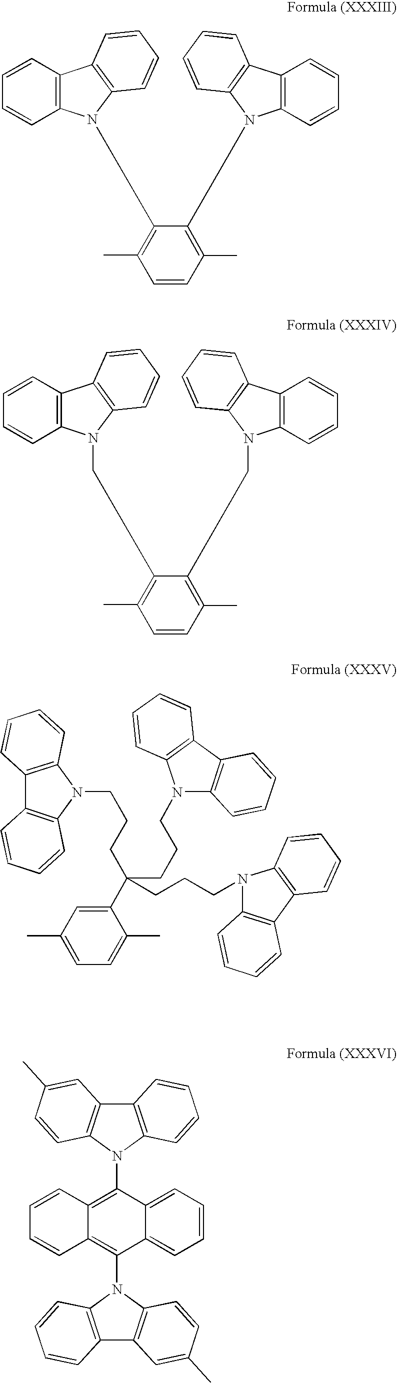

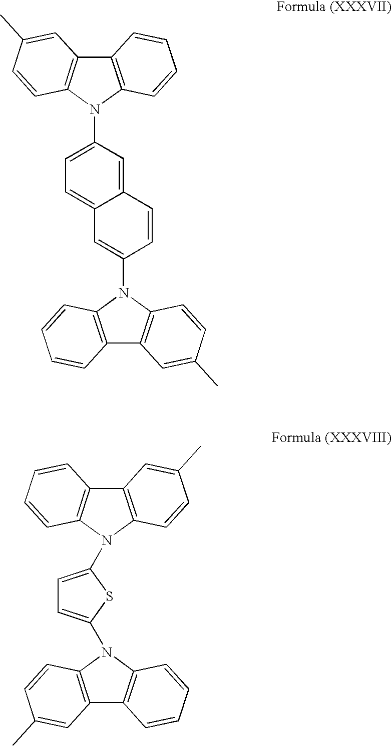

37. Mixtures as claimed in claim 7, characterized in that structural units of the formula (II) are additionally added to the mixture as claimed in claim 7 (BLEND4).
